(19) United States
(12) Patent Application Publication
(10) Pub. No.: US 2013/0069768 A1
(43) Pub. Date: Mar. 21, 2013

(54) SYSTEMS, DEVICES, METHODS AND COMPUTER-READABLE STORAGE MEDIA THAT FACILITATE CONTROL OF BATTERY-POWERED DEVICES

(71) Applicants: Maitreya Visweswara Madhyastha, Torrance, CA (US); Kellan Patrick O'Connor, Manhattan Beach, CA (US)

(72) Inventors: Maitreya Visweswara Madhyastha, Torrance, CA (US); Kellan Patrick O'Connor, Manhattan Beach, CA (US)

(21) Appl. No.: 13/554,149

(22) Filed: Jul. 20, 2012

Related U.S. Application Data
(60) Provisional application No. 61/509,710, filed on Jul. 20, 2011.

(51) Int. Cl. G08C 19/12

(52) U.S. Cl. CPC G08C 19/12
USPC 340/12.5

(57) ABSTRACT

Systems, methods, apparatus and computer-readable medium for controlling battery-powered devices are provided. In some embodiments, a control device can include radio frequency (RF) circuitry and be configured to: receive one or more RF signals from a controller; and control one or more operations of a battery-powered device located proximate to the control device based, at least, on the one or more RF signals. The one or more operations can include de-activating an operation of the battery-powered device, activating an operation of the battery-powered device or the like. In various embodiments, a system can include a control device that controls a battery-powered device and a controller that is communicatively coupled to the Internet and configured to output information associated with the state of the battery-powered device to social media networking sites.

### RELATED APPLICATIONS

This application claims the benefit of U.S. Provisional Application No. 61/509,710, filed Jul. 20, 2011, which is hereby incorporated by reference in its entirety.

### TECHNICAL FIELD

The subject disclosure relates to control of battery-powered devices, and more specifically, to control systems, devices, methods and computer-readable storage media that facilitate control of battery-powered devices.

### BACKGROUND

Currently, battery-powered devices are generally powered on or off by a user who manually switches the power on or off at the site of the battery-powered device. Toys, handheld and/or household devices (e.g., control devices, clocks, small televisions, radios) and even weapons peripherals are battery-powered in various cases and may be manually controlled by users of the devices and/or users that seek to control use of the devices by others (e.g., children). Unfortunately, requiring manual control of the battery power at the battery-powered device can reduce safety and convenience, and result in a limited amount of control over the use of the devices. As such, systems, devices, methods and computer readable media for controlling battery-powered devices are desired.

### SUMMARY

The following presents a simplified summary of one or more of the embodiments in order to provide a basic understanding of some aspects of the embodiments. This summary is not an extensive overview of the embodiments described herein. It is intended to neither identify key or critical elements of the embodiments nor delineate any scope of the embodiments or any scope of the claims. Its sole purpose is to present some concepts of the embodiments in a simplified form as a prelude to the more detailed description that is presented later. It will also be appreciated that the detailed description may include additional or alternative embodiments beyond those described in this summary.

In one or more embodiments, a control device is provided. The control device can include radio frequency (RF) circuitry and be configured to: receive one or more RF signals from a controller; and control one or more operations of a battery-powered device located proximate to the control device based, at least, on the one or more RF signals.

In one or more embodiments, a non-transitory computer-readable storage medium can store computer-executable instructions that, in response to execution, cause a system including a processor to perform operations. The operations can include: receiving, from a control device, a signal indicative of a state at a battery-powered device; and transmitting one or more RF signals to the control device based, at least, on the receiving the signal, wherein the control device is operably coupled to the battery-powered device, and wherein the one or more RF signals include information causing the control device to control operations of the battery-powered device.

In one or more embodiments, a computer-implemented method is provided. The method can include: detecting, by a system including at least one processor, an acceleration of a battery-powered device operably coupled to the system; and generating, by the system, a first control signal configured to control the battery-powered device to perform one or more operations based, at least, on the detecting.

In one or more embodiments, another control device is provided. The control device can include an application specific integrated circuit (ASIC) configured to: process one or more radio frequency (RF) signals; and generate signals to control one or more operations of a device located proximate to the control device based, at least, on the one or more RF signals, wherein the ASIC is coupled to a battery housing for the device. The control device can also include an antenna coupled to the battery housing.

The following description and the annexed drawings set forth certain illustrative embodiments of the embodiments. These embodiments are indicative, however, of but a few of the various ways in which the principles of the embodiments can be employed. Other features of the embodiments will become apparent from the following detailed description of the embodiments when considered in conjunction with the drawings.

### BRIEF DESCRIPTION OF THE DRAWINGS

Various non-limiting embodiments are further described with reference to the accompanying drawings in which:

FIG. 1 is a block diagram illustrating an exemplary non-limiting embodiment of a system configured to control battery-powered devices;

FIG. 2 is a block diagram illustrating an exemplary non-limiting control device configured to control battery-powered devices;

FIG. 3 is a circuit diagram illustrating an exemplary non-limiting control device configured to control battery-powered devices;

FIG. 4 is a block diagram illustrating an exemplary non-limiting embodiment of a circuit of a receiver for a control device configured to control battery-powered devices;

FIGS. 5A, 5B, 5C, 6A, 6B, 7A, 7B and 7C are schematic diagrams illustrating exemplary non-limiting embodiments of systems configured to control battery-powered devices;

FIGS. 8A and 8B are schematic diagrams illustrating exemplary non-limiting embodiments of systems configured to control battery-powered devices;

FIGS. 9A and 9B are schematic diagrams illustrating exemplary non-limiting embodiments of systems configured to control battery-powered devices;

FIGS. 10A and 10B are schematic diagrams illustrating views of a housing for control devices configured to control battery-powered devices;

FIGS. 11A and 11B are schematic diagrams illustrating views of the housing of FIGS. 10A and 10B;

FIGS. 12A and 12B illustrate diagrams of selected components for the housing of FIG. 11A and 11B;

FIG. 13 illustrates a schematic diagram of a circuit of a control device configured to control a battery-powered device;

FIG. 14 illustrates a schematic view of a housing for the control device configured to control the battery-powered device;

FIGS. 15 and 16 illustrate example flowcharts of methods that facilitate controlling battery-powered devices;

FIG. 17 illustrates a block diagram of a computer operable to facilitate controlling battery-powered devices;

FIG. 18 is an illustration of a schematic diagram of an exemplary networked or distributed computing environment with which one or more embodiments described herein can be associated; and

FIG. 19 is an illustration of a schematic diagram of an exemplary computing environment with which one or more embodiments described herein can be associated.

### DETAILED DESCRIPTION

One or more embodiments are now described with reference to the drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details (and without applying to any particular networked environment or standard).

As used in this application, the terms “component,” “module,” “system,” “interface,” “platform,” “service,” “framework,” “connector,” “controller” or the like are generally intended to refer to a computer-related entity, either hardware, a combination of hardware and software, software or software in execution or an entity related to an operational machine with one or more specific functionalities. For example, a component can be, but is not limited to being, a process running on a processor, a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. As another example, an interface can include input/output (I/O) components as well as associated processor, application, and/or application programming interface (API) components.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

Embodiments described herein can be exploited in substantially any wireless communication technology, including, but not limited to, Wireless Fidelity (Wi-Fi), Global System for Mobile Communications (GSM), Universal Mobile Telecommunications System (UMTS), Worldwide Interoperability for Microwave Access (WiMAX), Enhanced General Packet Radio Service (Enhanced GPRS), Third Generation Partnership Project (3GPP) Long Term Evolution (LTE), Third Generation Partnership Project 2 (3GPP2) Ultra Mobile Broadband (UMB), High Speed Packet Access (HSPA), Zigbee and other 802.XX wireless technologies and/or legacy telecommunication technologies.

Battery-powered devices are typically supplied power via one or more primary or re-chargeable batteries connected in series to achieve a nominal voltage, typically approximately 1.5 to approximately 12 volts. The primary or re-chargeable batteries are located on-site with the battery-powered devices. The most common battery used in these battery-powered devices is of the AA size. Other sizes (e.g., C or D), while sometimes used, are less popular but are often chosen when a higher current capacity is required or when the form factor/housing for the battery-powered device does not permit the packaging of larger battery sizes. Some battery-powered devices use pre-arranged voltage supplies, the most popular being the 9V. Still other battery-powered devices use custom-designed battery packs that are optimized to fit unique packaging requirements. Such battery packs may contain one or more disposable or re-chargeable cells, which may be configured to achieve the power supply requirements (e.g., voltage and/or current density) required for adequate function of the battery-powered device.

In one or more embodiments described herein, a control device is provided. The control device includes RF circuitry and can be configured to: receive one or more RF signals from a controller; and control one or more operations of a battery-powered device located proximate to the control device based, at least, on the one or more RF signals.

In other embodiments, a controller is provided. The controller can receive, from a control device, a signal indicative of a state of a battery-powered device. The controller can then transmit one or more RF signals to the control device based, at least, on receipt of the signal. The control device can be operably coupled to the battery-powered device, and the one or more RF signals can include information causing the control device to control operations of the battery-powered device. For example, in some embodiments, the control device can control activation and/or deactivation of the battery-powered device. In some embodiments, the controller can be communicatively coupled to the Internet and transmit information about the battery-powered device (or the environment in which the battery-powered device is located) to one or more social networking sites. The activation and/or deactivation can be based on motion being detected and/or time elapsing on a timer in various embodiments.

One or more of the embodiments described herein advantageously provide for control of battery-powered devices from locations remote from the battery-powered devices. In addition, one or more embodiments advantageously provide for communication via social networking websites, text messaging or the like regarding the state of the battery-powered device and/or an environment in which the battery-powered device is located.

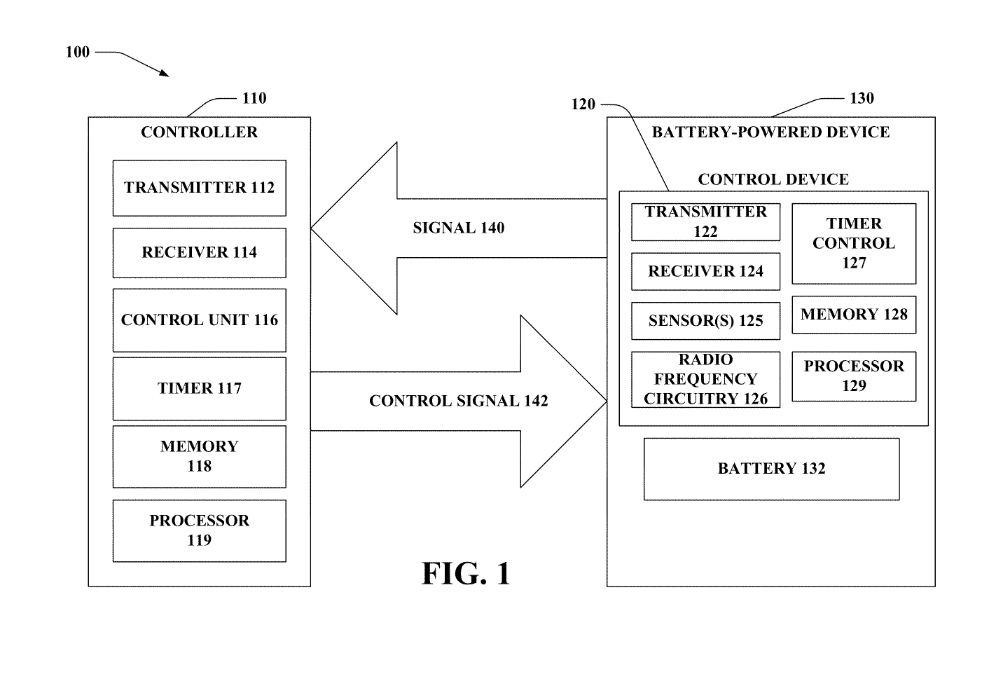

These and other embodiments are described in detail below. Turning first to FIG. 1, FIG. 1 is a block diagram illustrating an exemplary non-limiting embodiment of a system configured to control battery-powered devices. The system 100 includes a controller 110, a control device 120 and/or a battery-powered device 130. In some embodiments, the system 100 includes only a control device 120 and a battery-powered device 130. In some embodiments, the system 100 includes only a control device 120. As shown, the control device 120 can be provided within a housing of the battery-powered device 130 in some embodiments.

In various embodiments, the controller 110, control device 120 and/or battery-powered device 130 can be electrically and/or communicatively coupled to one another to perform one or more functions of the system 100. For example, the controller 110 can receive a signal 140 from the control device 120 and/or transmit a control signal 142 to the control device 120.

In some embodiments, the controller 110 transmits the control signal 142 in response to receiving the signal 140 from the control device 120. In various embodiments, the control signal 142 can provide information to the control device 120 to cause the control device 120 to control one or more operations of the battery-powered device 130 in one or more ways as described in further detail throughout this disclosure. The control signal 142 can include one or more commands originating from the controller 110 that govern the behavior of the control device 120 upon receipt of the commands by the control device 120. For example, the commands can be or include information indicative of inputs to the control device 120. The control signal 142 from the controller 110 can control power (e.g., switch on/off), perform power-level monitoring, perform disturbance monitoring, perform proximity monitoring and/or manage/assign timing functionality at a battery-powered device (e.g., battery-powered device 130).

As another example, the commands can cause the control device 120 to internally-generate commands, operations or information that can be employed in controlling the battery-powered device 130 to perform one or more operations.

In various embodiments, the signals communicated between the controller 110 and the control device 120 can be RF signals. In some embodiments, the signals between the controller 110 and the control device 120 can be any signals able to be transmitted and/or received on frequencies able to be processed by the RF circuitry (e.g., RF/electronic circuitry 400, 126) at the control device 120.

Sending and/or receiving signals can be performed either directly via integral phone carrier signals, or indirectly via a network interface with a wireless router or similar wireless transceiver.

In some embodiments, the controller 110 is capable of storing data (up to a reasonable limit) that it receives from the control device 120 and/or can be capable of porting such data to a network server so that the data may be stored and recovered at a later time. Thus users can be able to access a history of data gathered from usage sessions and possibly use this data to compile reports and/or share with other users in a social manner and/or over a social network.

In some embodiments, the controller 110 and the control device 120 can communicate with one another via a wireless channel. The wireless channel can be any number of different wireless channels (operating according to any number of different protocols) and over any number of different types of networks including but not limited to, a cellular channel (e.g., if the controller is a cellular telephone, for example), wireless local area network (WLAN) or wireless fidelity (Wi-Fi) channels, BLUETOOTH® channels (including BLUETOOTH® low energy channels) or the like.

In various embodiments, the controller 110 can be any personal, mobile, stationary and/or handheld device capable of communicating information via RF signals with the control device 120. By way of example, but not limitation, the controller 110 can be a mobile device (e.g., smart phone, key fob) or other computing device (e.g., laptop, personal computer (PC)).

The controller 110 can include a transmitter 112, receiver 114, control unit 116, memory 118 and/or processor 119. In one or more embodiments, the transmitter 112, receiver 114, control unit 116, memory 118 and/or processor 119 can be communicatively and/or electrically coupled to one another to perform one or more functions of the controller 110. In one or more embodiments, the structure and/or functionality of the transmitter 112 and receiver 114 can be replaced with a transceiver that can transmit and receive information.

The transmitter 112 can transmit information (e.g., control signal 142) to the control device 120. The information can be transmitted via an RF signal emitted from the transmitter 112 in some embodiments. The receiver 114 can receive information (e.g., signal 140) from the control device 120. The signal 140 can also be an RF signal. By way of example, but not limitation, the control device 120 can detect motion of the battery-powered device 130 and transmit signal 140 to the controller 110. The signal 140 can include information indicating that motion has been detected. The controller 110 can respond to the control device 120 by transmitting a control signal 142 to the control device 120 to cause the control device 120 to perform one or more functions for controlling the operation of the battery-powered device 130 in light of the detected motion.

In embodiments wherein the controller 110 is a smart phone, dongle (or any other type of computing device) and the transmitter 112 or receiver 114 does not communicate on the same frequency as the receiver 124 of the control device 120, the controller 110 can include a component configured to translate a signal generated by the smart phone (or computing device) from the smart phone (or computing device) frequency to the frequency of the receiver 124 of the control device 120. In some embodiments, the frequency can be 868 Mega Hertz (MHz) or higher due to antenna packaging.

The component configured to translate the frequency can be or can be included with a repeater. The repeater can be included as part of, or communicatively coupled with, the controller 110. In some embodiments, the repeater can be located at a location remote from the controller 110. In some embodiments, the repeater may be configured to run software or firmware, and/or interface via communication channels to Internet accessible programs that assist or govern the control of the control device 120.

In some embodiments, a smart phone application can be employed when the smart phone is used as the controller 110. The smart phone application can enable a user of the smart phone to select one or more control device receivers at the one or more battery-powered devices, teach the receivers unique activation codes, and then provide a method for selecting the operational states of the battery-powered devices within a particular range. For example, an icon representative of a potential battery-powered device that can be controlled can be displayed to the user and/or selected. The icon can be user-defined in some cases. For example, an icon of a toy to be switched off can be displayed to the user.

In some embodiments, the icon could be a user taken photo of the device which that icon controls. The icon could furthermore lead to sequential screens that allow multitudes of user definable behaviors to be set up, e.g. timing, motion sense, proximity, thresholds of sensitivity for motion detection, thresholds for activation from the current sensing comparator (e.g. at what level of current draw should the device be allowed to operate), etc. An added benefit of this can be that the control devices could allow users functionality for preventing parasitic power losses from devices that are constantly drawing power for low level operations. In this way, devices behaviors with respect to the operators can be partially or completely revamped.

Additionally, through the use of the smart-phone or computer software communicatively coupled to the control devices in the aforementioned manners, data pertaining to the usage of the device can be harvested, stored, and periodically relayed to the controller device to be presented to an end user. By way of example, but not limitation, statistics pertaining to game play, battery use, amount of time the device was in motion, roughness of play or device acceleration, battery status, time of last battery change, detection of a leaking or shorted battery, number of charge cycles accumulated on a device and/or status of fuse or if device entered a safe mode. One or more of or all such data could potentially be stored on a network server to be accessed at some point in the future by the user and possibly shared amongst other users in a social way (e.g., over a social network).

While the smart phone is described herein as an example device that can be employed to perform the functions described herein, in other embodiments, any number of different types of computing devices/platforms that can be employed in place of or in addition to a smart phone device. The computing devices/platforms can be communicatively coupled to the control device can include, but are not limited to, IPAD® devices, IPHONE® devices, IPOD® devices, smart phones, tablet personal computers (PCs), PCs, laptops, etc.

In some embodiments, the controller 110 can detect the presence of the control device 120. As such, although not shown in FIG. 1, in some embodiments, the controller 110 can include a graphical user interface (GUI) and functionality to display a picture of the battery-powered device 130 associated with the control device 120 when the control device 120 is detected. Accordingly, a user using the controller 110 can determine the component that will be controlled as a result of the control signal 142 generated by the controller 110 by viewing the GUI.

The control unit 116 of the controller 110 can generate information included with the control signal 142 in some embodiments. In some embodiments, the information can be indicative of the commands that cause the control device 120 to be controlled or that cause the control device 120 to control the battery-powered device 130. For example, the control unit 116 can generate information indicative of commands for causing the control device 120 to remain powered on for a certain amount of time. As another example, the control unit 116 can generate information indicative of commands for causing the control device 120 to control the battery-powered device 130 by interrupting the operation of or de-activating the battery-powered device 130, activating the battery-powered device 130, electrically disconnecting the battery supply of the battery-powered device 130 from the control device 120, electrically disconnecting the battery supply of the battery-powered device 130 from the battery-powered device 130 while maintaining power to the control device 120, re-activating a battery-powered device 130 that has been de-activated or for which operation has been interrupted, and/or controlling the control device 120 to remain on for a certain amount of time. In various embodiments, activating, de-activating, interrupting and/or electrically disconnecting can be initiated at the discretion of the operator of the controller 110 and/or based on time of day, day of week, month of year, determination that motion has been detected at the battery-powered device, after the passage of a predetermined amount of time, after a certain amount of time has elapsed from a timer, proximity to the control device or the like.

Accordingly, in such embodiments (e.g., where toys are the battery-powered devices being controlled, for example), parental control of the use of a toy by a child can be implemented whereby the parent can employ the controller 110 to turn on or off (or otherwise control the toy) from a location that is remote from the battery-powered toy location.

In some embodiments, the control unit 116 can be a multipoint control unit configured to enable the controller 110 to control multiple different control devices located at different battery-powered devices. The control can be concurrent and/or in sequence, in various embodiments.

For example, in some embodiments, multiple battery-powered devices can be controlled from a single controller 110 (e.g., a single smart phone). In such embodiments, a learn mode can be entered (and/or a behavioral mode initiated) between the controller 110 and the receiver 124 of the control device 120 configured to control the battery-powered device 130. The learn mode can be employed to teach the controller 110 and control device 120 a suitable communications protocol by which to communicate. The learn mode can be activated in response to or based on shaking the receiver 124 (which results from shaking the battery-powered device 130 at which the control device 120 having the receiver 124 is located). In some embodiments, the mode can be activated or initiated upon a particular sequence of shaking movements. By way of example, but not limitation, for example, four consecutive shakes at roughly 2 second intervals can initiate or activate the mode.

In some embodiments, the control device 120 can detect shaking motion and an indicator can be made to the controller 110 to enter the learn mode. For example, the control device 120 can detect shaking and a user of the controller 110 can depress a button or otherwise physically control the controller 110 to enter the learn mode. As such, in some embodiments, no external buttons or switches are required on the control devices (or receivers in the control devices) to enable a learning mode of a user selected control (or receiver) device. To detect shaking, the motion switches can be coupled with the transmitters/receivers at the control devices, and the controller 110 can control the control devices based on the signals received from the transmitters after motion detection at the control devices. In some embodiments, a control unit (e.g., control unit 116 of FIG. 1) at the controller 110 can control the control devices. In any of the embodiments, the control unit can be a multipoint control device (MCU).

In some embodiments the motion switch can work in tandem with a transmitter that has a transceiver. In some embodiments, the shaking motion, if accompanied by an extended key or key pairing depression on a key fob transmitter or computer/smart phone application screen, can teach the control device 120 the required frequency/code. In some embodiments, facilitating multiple frequencies, and added functionality to a typical smart phone can be employed via the BLUETOOTH® protocol and/or WI-FI network. In some embodiments, the software can likely auto-detect control devices within range and allow the user to assign individual codes to each unit.

In some embodiments, the controller 110 can include a timer 117 that can enable the control unit 116 to determine an amount of time that has passed since an operation has been commanded to be performed by the controller 110. For example, the timer 117 can indicate that the battery-powered device 130 was de-activated two hours ago. The control unit 116 can then determine whether activation of the battery-powered device 130 is allowed should motion be detected at the battery-powered device, for example.

The memory 118 can be a computer-readable storage medium storing computer-executable instructions and/or information for performing the functions described in this disclosure with reference to the controller 110. In some aspects, the memory 118 can store information including, but not limited to, time of day, day of year or month of year at which to cause one or more operations to be performed at the battery-powered device 130, a time at which a particular operation was performed at the battery-powered device 130 (e.g., the battery-powered device 130 was de-activated at 3 p.m. on Monday), an amount of time that has passed since an operation was commanded to be performed at the battery-powered device 130 or the like.

The processor 119 can perform one or more of the functions described in this disclosure with reference to the controller 110 (or components thereof).

The control device 120 can include a transmitter 122, receiver 124, one or more sensors 125, RF circuitry 126, timer control 127, memory 128 and/or processor 129. In various embodiments, one or more of the transmitter 122, receiver 124, one or more sensors 125, RF circuitry 126, timer control 127, memory 128 and/or processor 129 can be electrically and/or communicatively coupled to one another, to the battery-powered device 130 and/or to the controller 110.

The transmitter 122 can transmit information (e.g., signal 140) to the controller 110 in various embodiments. The information can be transmitted via an RF signal. The receiver 124 can receive information (e.g., control signal 142) from the controller 110. By way of example, but not limitation, the control device 120 can transmit information such as an indicator that motion has been detected at the battery-powered device 130.

In some embodiments, although not shown, the control device 120 includes an audio component configured to receive audio commands for causing the control device 120 to control the battery-powered device 130. For example, audio detection can be included in the control device 120 and/or controller 110 as follows. A microphone or audio detection device can receive and/or detect sounds or voice commands and cause operations to be performed that control the battery-powered device 130 based on the sounds and/or voice commands. The audio detection device can be provided at the control device 120 while the microphone can be provided by the controller 110, for example.

In some embodiments, the transmitter 122 and receiver 124 described herein can be adapted for rechargeable battery packs that are used with hand-held gaming consoles, digital cameras and a number of other common consumer electronic devices. The same communication methods and components described herein can be, in a similar fashion, embedded within the typical rectangular body of rechargeable battery pack allowing for users to control the delivery of power (and manage other actions) for devices that receive power from such packs.

The control device 120 can be manually updated in some embodiments. In other embodiments, the control device 120 can be re-configured based on information received at the receiver 124 of the control device. For example, the control device 120 can be configured (or re-configured) to adjust the frequency at which the receiver 124 transmits and/or at which the transmitter 122 receives updates to attribute variables of the control device 120, and/or for how long a higher duty cycle on the transmitter 122 will be in effect.

In some embodiments, the control device 120 can be in a hibernation mode whereby a transceiver of the control device 120 hibernates and does not receive information. The transceiver can awake during certain time periods or on certain days, for example. For example, the transceiver can advertise at a certain frequency (e.g., a certain number of times per minute or hour). However, if it is known in advance that no changes in control of the control device 120 will be made during certain time periods (e.g., between the hours of 9 am and 3 pm, Monday through Friday), the control device 120 can awake (and the components of the control device 120 can operate) less frequently during such time period. Accordingly, the battery life of battery 132 can be extended.

In other embodiments, the transceiver (or transmitter 122 and receiver 124) and/or RF circuitry 126 may be configured to perform functions other than those described. For instance, the control device 120, as commanded or assigned by the controller 110, can be configured to perform a delay shut off whereby the battery-powered device 130 is controlled by the control device 120 to turn off after a designated amount of time of being turned on. For example, a sequence of one or more button depressions (or selection of options at a touch screen associated with or on the controller 110 (e.g., smart phone application screen)) can be entered to activate a countdown timer. The countdown timer can countdown before the control device 120 de-activates the battery-powered device 130. In some embodiments, the controller 110 may instruct the control device 120 to remain turned on for a certain amount of time. Accordingly, passive means of parental control are enabled with embodiments described herein by automatically controlling the battery-powered device 130 to perform an operation (e.g., de-activation) after a certain amount of time.

In some embodiments, the control device 120 can include one or more of the functionality of the controller 110 since the control device 120 contains transmission capability. This can allow for a multitude of micro-network scenarios, for instance in one embodiment, a room can be filled with spheres capable of illumination. The controller devices can affect a game play whereby the object of the game is to pick up the glowing sphere (the particular sphere glowing at any time can be a function of a random program and one sphere randomly selecting a neighboring sphere to illuminate). The timing interval can be adjusted via the software, perhaps running on a home computer or smart phone. In these embodiments, the home computer or the smart phone can communicate with the control device 120 directly, through a home network and/or via the Internet (e.g., in a social media context) in various embodiments.

The one or more sensors 125 can be one or more motion sensors configured to detect motion of the battery-powered device 130 in some embodiments. For example, in some embodiments, the one or more sensors 125 can be components that detect acceleration of the battery-powered device 130.

Upon detection of motion, the control device 120 can send a signal (e.g., signal 140) to the controller 110. The signal can indicate that motion has been detected at the battery-powered device 130. In response to receipt of the signal 140 indicating that motion has been detected, the controller 110 can send a control signal 142 to the control device 120 causing the control device 120 to turn the battery-powered device 130 on. The signal can also, in some embodiments, cause the control device 120 to turn the battery-powered device 130 on after a designated period of time has passed after the motion was detected.

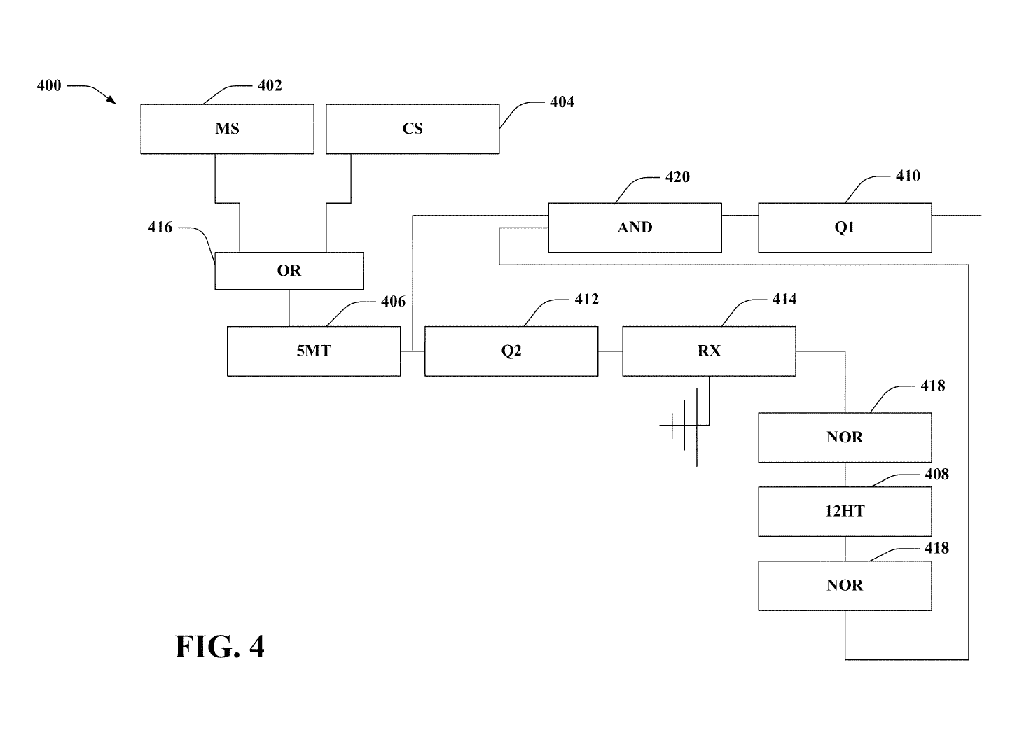

In some embodiments, the one or more sensors 125 can include a motion switch (e.g., motion switch 402 described herein with reference to FIG. 4). In some embodiments, the motion switch can have sufficient sensitivity such that motions of a small child can be sensed and a small child can therefore effectively cause the battery-powered device 130 to be activated by moving the battery-powered device 130. For example, the motion switch can be configured to sense omni-directional accelerations of approximately 0.1 G in some embodiments.

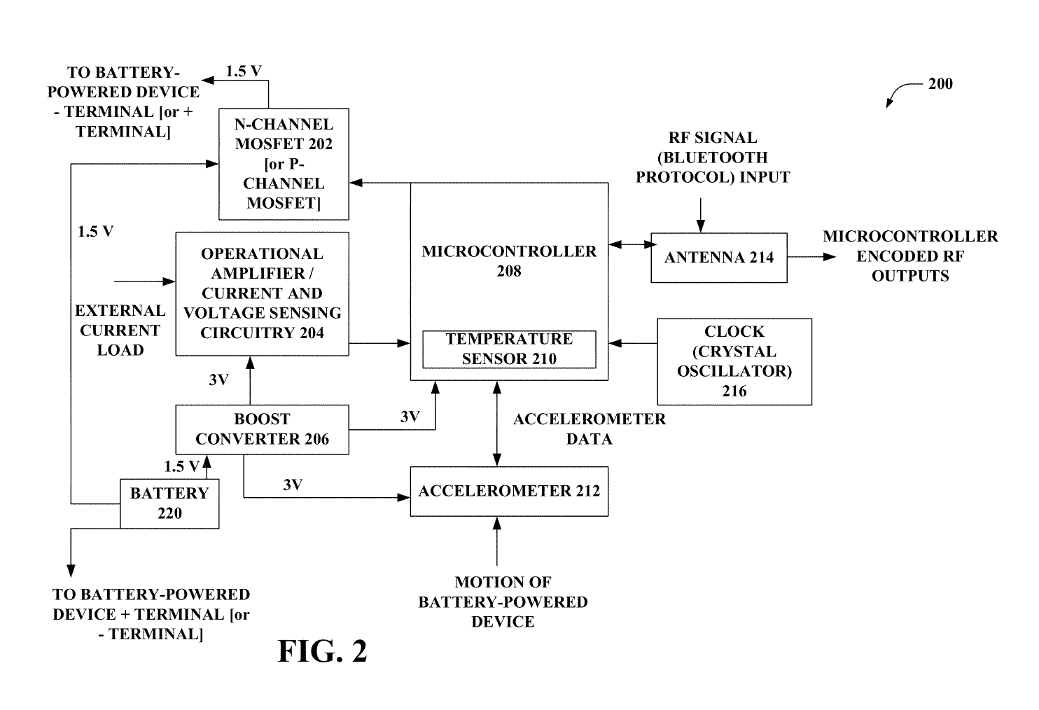

In some embodiments, motion detection can be performed as follows. The one or more sensors 125 can include a motion sensing device (e.g., accelerometer 212 described herein with reference to FIG. 2) that allows a receiving component within the receiver 124 to remain dormant until motion or movement of the battery-powered device 130 in which the receiver 124 is located, is sensed. Once the motion sensing device is activated, the receiving component powers on and begins searching for an incoming signal from the transceiver (or transmitter 112) of the controller 110.

In some embodiments involving the one or more sensors 125, the system 100 can alert a user, through the transceiver (or transmitter 112) of the controller 110, that the battery-powered device 130 has been moved. In some embodiments, such an alert could take the form of a text message, e-mail, ringtone, audible alarm, or other device or functionality pertinent to the context of the system in use (e.g. depending upon which device is functioning as the controller 110, one form may be employed in lieu of or in addition to another form). One or more movements or disturbances can be recorded on the controller 110 and/or on a network server to generate a history log of disturbance. The log can be accessed for subsequent use or information.

In various embodiments, the one or more sensors 125 can be or include motion, sound, accelerometer, temperature, pressure, light or other sensing functionality (or other sensors) in various embodiments to enhance the intelligence of the control device 120.

The control device 120 can include RF circuitry 126, which can be powered by a consumer battery (e.g., AA or AAA battery) such as that typically included in a battery-powered device (typically for powering the battery-powered device). The RF circuitry 126 can be configured to send and/or receive RF signals to and/or from the controller 110.

In some embodiments, the RF circuitry 126 of the control device 120 is configured to be powered solely by the battery 132. For example, the circuitry that powers the control device 120 can upconvert the voltage of battery 132 to a voltage required for powering the RF circuitry 126.

While the battery 132 is shown external to the control device 120, in some embodiments, the battery 132 is a part of the components that make up the control device 120 and/or is included within a housing to which an integrated circuit (IC) including the control device components is coupled. By way of example, the circuitry of the control device 120 can be integral and operatively coupled to the enclosure of a primary battery optimized by those skilled in the art to accept the circuitry of the control device 120.

The timer control 127 can be configured to control the control device 120 to perform one or more functions associated with control of the battery-powered device 130. For example, the timer control 127 can include functionality and/or structure for one or more of a sleep timer, awake timer, on timer, off timer, timers that extend and or limit the intervals that certain modes of operation (e.g., power-intensive modes of operation) of the control device 120 are active, in order to better optimize battery life and improve responsiveness to the end user. In some embodiments, for example, the timer control 127 can determine the time remaining for the sleep timer.

Upon expiration of the time assigned to the sleep timer, the control device 120 can awaken. Upon awakening, the control device 120 can perform one or more functions for control of the control device 120 and/or for control of the battery-powered device 130, for example.

In various embodiments, information indicative of the timer values maintained by the timer control 127 can be provided to an end user via a transmitted signal to a controller. For example, information can be output indicative of a remaining time that the control device 120 and/or battery-powered device 130 will be dormant, a remaining time until a control device 120 and/or battery-powered device 130 will be activated and/or whether a battery-powered device 130 will be activated if motion of the battery-powered device 130 is detected.

The memory 128 can be a computer-readable storage medium storing computer-executable instructions and/or information for performing the functions described in this disclosure with reference to the control device 120. In some aspects, the memory 128 can store information including, but not limited to, time of day, day of year or month of year at which to cause one or more operations to be performed at the battery-powered device 130, a time at which a particular operation was performed at the battery-powered device 130 (e.g., the battery-powered device 130 was de-activated at 3 p.m. on Monday), an amount of time that has passed since an operation was commanded to be performed at the battery-powered device 130 or the like.

In some embodiments, the memory 128 can store information for re-configuring the control device 120 to perform new and/or different functions from those described. For example, the control device 120 can be re-configured to allow for control of the battery-powered device 130 via new functions and/or operations. For example, the memory 128 can be re-configurable with new functions, etc. for new operations.

The processor 129 can perform one or more of the functions described in this disclosure with reference to the control device 120 (or components thereof).

In various embodiments, the control device 120, RF circuitry 126 and/or processor 129 can be configured to control the battery-powered device 130 to perform a number of different operations. For example, the battery-powered device 130 can be controlled to perform the following operations including, but not limited to, interrupting the operation of or deactivating the battery-powered device 130 (e.g., serving as a “kill switch”); electrically disconnecting the battery supply of the battery-powered device 130 from the battery-powered device 130 (e.g., serving as a parental or other type of control device to shut down toys or other electronics after a designated period of time); electrically disconnecting the battery supply of the battery-powered device 130 from the battery-powered device while maintaining power to the control device 120; re-activating a battery-powered device 130 that has been de-activated or for which operation has been interrupted; and/or activating the battery-powered device 130 (e.g., activating the battery-powered device 130 based on detected motion of the battery-powered device 130). In some embodiments, upon activating the battery-powered device 130, the RF circuitry 126, control device 120 and/or processor 129 can perform any number of the above-described functions alone or in combination. In some embodiments, upon activating the battery-powered device 130, the RF circuitry 126, control device 120 and/or processor 129 can be configured to be able to perform the above-described functions for a designated amount of time after motion of the battery-powered device is detected. In some embodiment, the RF circuitry 126, control device 120 and/or processor 129 can turn the battery-powered device 130 on or off after a designated period of time.

As shown, the battery-powered device 130 includes a battery 132. The battery 132 can be electrically coupled to the control device 120 to power the control device 120 in various embodiments. For example, when the battery 132 is inserted into the circuit of the control device 120, the control device 120 can be powered on.

While the control device 120 is on, the control device 120 can maintain at least two states: a peripheral state and a listening state. When the control device 120 is in the peripheral state, the battery 132 can be connected to the terminals of the battery-powered device 130. The peripheral state can be independent from the listening state.

When the control device 120 is in the listening state, the control device 120 can be in an awake state or a sleep state. In the sleep state, the control device 120 can be awaked by detection of motion by the control device 120 (e.g., lightly shaking the battery-powered device 130 in which the control device 120 is located). In this embodiment, the control device 120 can have sensing capability that operates while the control device 120 is in the sleep state to awaken upon detection of motion. The control device 120 can also (or alternatively) be awaken based on the operation of a timer (which can be programmed via the control signal 142 or pre-programmed in the processor 129 at time of purchase of the control device 120 or prior to the first use of the control device 120).

When the control device 120 is in the awake state, the control device 120 can constantly broadcast the presence of the control device. In these embodiments, the signal broadcast can be a BLUETOOTH® signal, and the controller 110 can detect the signal using a BLUETOOTH® Low Energy-enabled phone or scanner.

The control device 120 can be operated in an open mode, which does not require a passphrase to access the control device 120. However, the connection between the control device 120 and the controller 110 may not be maintained for more than a second in some embodiments. In these embodiments wherein a passphrase is not employed, the transmitter 112 of the controller 110 can be authenticated by writing a FAMILY_ID attribute before reading or writing any other parameter in the session with the control device 120. If the FAMILY_ID attribute matches the pre-programmed identifier at the control device 120, the control device 120 may then allow access to the transmitter 112. The identifier can be set when the control device 120 is first turned on (e.g., when a new battery is inserted). In various embodiments, the control device 120 can adopt the first FAMILY_ID attribute detected by the control device 120.

When a connection between the controller 110 and the control device 120 is made, one or more of several parameters/attributes can be read from the control device or written to the control device 120. The attributes can be communicated via an antenna of the control device 120 and will be discussed in greater detail with reference to FIG. 2.

In various embodiments, although not shown in FIG. 1, the controller 110 can be communicatively coupled, via the Internet (not shown) or via a telecommunications carrier, to a home network (not shown). In some of these embodiments, the home network can be included in system 100.

For example, the home network can be within broadcasting range to one or more receivers in a control device 120 in the home. In some embodiments, the receivers (e.g., receivers such as receiver 124) can be located proximate to the control devices (e.g., control device 120) or located remote from but communicatively coupled to one or more control devices.

In these embodiments, the controller 110 can control one or more battery-powered devices from great distances (e.g., by transmitting information (e.g., control signal 142) via the Internet or a home network to a battery-powered device (e.g., battery-powered device 130) having a control device (e.g., control device 120).

In some embodiments, the control device 120 can communicate the information sensed from the one or more sensors 125 to a base station (BS) or computing device (e.g., controller 110) communicatively coupled to the Internet. The information can include, but is not limited to, a state of the battery-powered device 130 or the home/environment in which the battery-powered device is located.

The computing device can include one or more of the structure and/or one or more functionality of the controller 110 described above. Upon receipt of the information, the computing device, for example, can retrieve information via the Internet that can be employed in conjunction with the sensed information. A number of different operations can then be performed via the control device 120 based on information provided by the computing device.

By way of example, but not limitation, the battery-powered device 130 can be a bicycle light housing and the control device 120 can reside inside the housing. The control device 120 can communicate with a computing device nearby (e.g., smart phone worn by a rider of the bicycle). In various embodiments, the computing device can include one or more of the structure and/or one or more of the functionalities of the controller 110 described above. The computing device can access the Internet and determine the time for sunset. The computing device can then generate information to cause the control device 120 to control the bicycle light to turn on at the time corresponding to dusk in the time zone in which the bicycle rider is located.

In some embodiments, a communication channel can be automatically established between the computing device and the control device 120 when the control device 120 is within a particular geographic proximity to the computing device. As such, the computing device can sense the presence of the control device 120 and communicate accordingly. For example, the sensing can be performed according to the BLUETOOTH® protocol.

By way of another example, but not limitation, the computing device can communicate the information retrieved from the Internet, or actions taken by the computing device or information sent to control the control device 120, via a social media channel and/or network associated with an owner of the control device 120 or with any other designated persons. As such, information can be sent and/or received over long distances from multiple popular data pipelines for safety, convenience, etc.

The social media channel and/or network can include, but is not limited to, FACEBOOK®, TWITTER® or the like. For example, parents of a bicycle rider can receive a notification via a social media channel or network indicating that the bicycle rider is riding with the bicycle light on. As another example, a smoke or carbon monoxide detector can be the battery-powered device having the control device 120. In these embodiments, the control device 120 can communicate, via a computing device and/or the Internet, with a designated person, if the smoke or carbon monoxide detector operates in a manner indicating that the alarm has been activated (or indicating that a level of smoke or carbon monoxide has been detected). A notification such as a social networking message (e.g., Tweet) or a short message service (SMS) message could be generated and transmitted to a designated person.

As another example, a text or tweet could be received by the control device 120 (via the computing device coupled to the Internet). The text or tweet can be translated into a command for the control device 120. The control device 120 can therefore take any number of operations based on commands or information received remotely via the Internet and provided to the control device 120 via a computing device in broadcasting range to the control device 120.

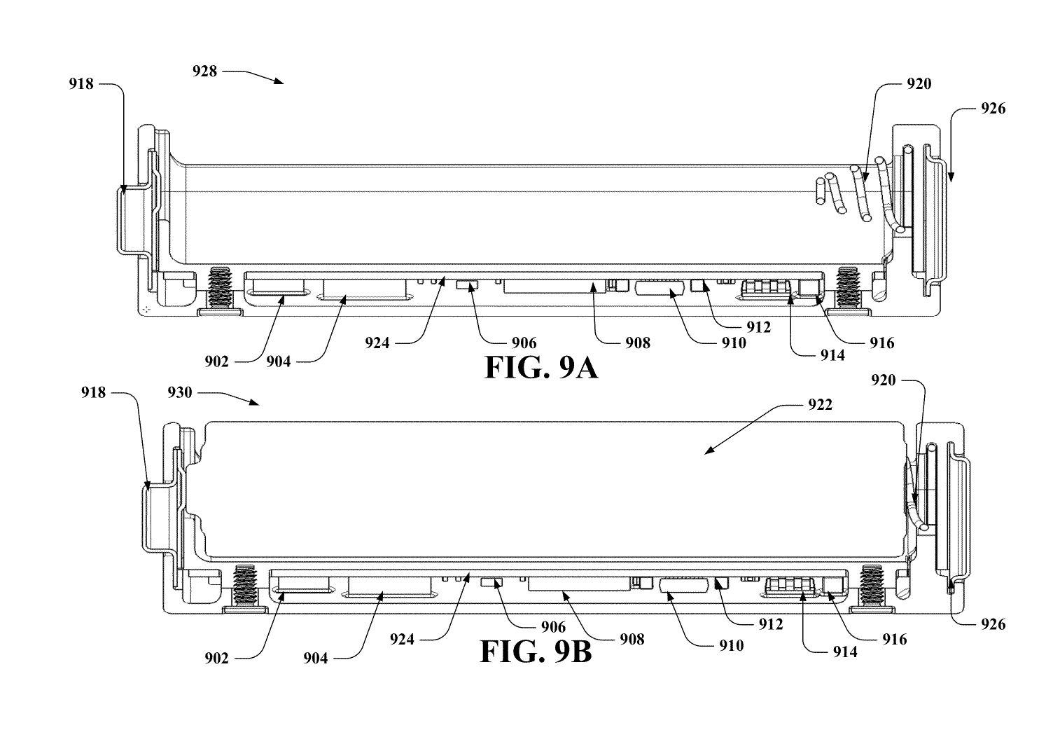

While the embodiments described include a control device 120 within a housing (e.g., housing 928, 930 described herein with reference to FIGS. 9A and 9B) of the battery-powered device 130, in various embodiments, the control device 120 could be located at a location outside of the housing of the battery-powered device 130. In these embodiments, the battery-powered device 130 can include a transmitter and/or receiver to receive information from the control device 120 for performing one or more functions (e.g., activating, de-activating, etc.).

In various embodiments, any of the functionality described for the controller 110 and/or the control device 120 can be implemented via software, firmware and/or hardware of a device. For example, any of the functionality described for the controller 110 and/or the control device 120 can be implemented via software, firmware and/or hardware of a smart phone. In some embodiments, the functionality can be provided via an application that can be added to and run on the smart phone. As such, the smart phone can be adapted to be a controller 110 in some embodiments.

In some embodiments, the smart phone can be adapted to be a control device 120 or controller 110 that can control the smart phone itself and/or that can control battery-powered devices in broadcasting range to the smart phone. For example, the smart phone can generate commands for controlling a control device (e.g., control device 120) and/or the smart phone can generate commands for controlling the battery-powered device that is either located at the location of the smart phone or located remote from the smart phone.

The smart phone can communicate with the Internet in some embodiments. As such, a control device (e.g., control device 120) can sense or determine other information as described above, and the smart phone can receive the sensed information and access the Internet to provide information to the control device (such as the example controlling the bicycle light) and/or to transmit information to be shared via a social networking media or channel and/or to transmit information to be shared via text message or the like.

Similarly, the smart phone can serve as a conduit for receiving information (e.g., text messages) that can be employed to control the operation of the control device (such as the smoke/carbon monoxide example).

In general, the embodiments of the control device 120 described herein can be characterized as those having embedded intelligence within the body of an electrochemical cell.

In other embodiments, remote switching can be included in system 100. For example, the receiver 124 can have the same (or similar) form factor/housing as a typical AA battery (as described above with reference to FIG. 1). The receiver can include an AAA battery power source and a control circuit. The transmitting function can be performed by a control (similar to a key fob) or a smart phone that can communicate across a BLUETOOTH® or other signal protocol. The system can be adapted for popular devices using rechargeable battery packs (e.g., parental control for hand-held video gaming systems, cellular telephones, any battery operated device, not limited to those using standard battery form factor/housings). In some embodiments, an in-line switch for an alternating current (AC) power adapter (or wall plug) can be controlled in the same manner, or integrated within the AC power adapter (or wall plug) itself, as some battery powered devices offer the alternative of being powered by a plug-in AC to direct current (DC) adapter.

In other embodiments, power delivery timer and/or operation schedules can be included in system 100. For example, power from battery 132 can be delivered to the control device 120 over a specified time period. The user can control the controller 110 to remotely activate the receiver 124 of the control device 120, and activate a countdown timer (e.g., timer control 127), giving a time-limit for which interaction with a battery-powered device 130 can be performed.

In some embodiments, power schedules can be included in system 100. For example, power schedules can be established wherein the receiver 124 at the control device 120 operates at certain times of the day for specified amounts of time. The schedule for the receiver 124 can be dynamic or fixed and/or adjusted via a control signal (e.g., control signal 142) of the transmitter 112 of the controller 110.

In some embodiments, light detection and/or solar re-charging can be included in system 100 as part of the functionality of the control device 120 and/or the controller 110. For example, a photovoltaic sensor can be incorporated to detect the presence of light, or a photovoltaic cell can be employed to recharge a battery or other integral electrical storage device.

In some embodiments, a peer-to-peer sensing embodiment can be included in system 100. For example, receivers at one or more control devices, through exchanged signals, can sense other receivers at one or more other control devices. For example, BLUETOOTH® low energy (BLE) signals or a comparable LAN signals can be transmitted to the one or more control devices for the peer-to-peer sensing. Because the receivers can sense other receivers in a geographical area, different operational schemes can be employed. For example, an operational scheme can be employed whereby only a designated number of receivers of control devices in an area are allowed to be powered-on completely. In one embodiment, multiple toys can include multiple respective control devices with respective receivers. A practical example can be seen when a child plays with one toy, then goes to pick up another. The toy controlled by the first control device can send a signal to all other control devices of other battery-powered devices to determine if any other toy is in play. If no other toys are in play, the first control device can allow the child's toy to power on. If, however, another control device is powered on, the first control device may then instruct the toy that is already powered on to power down. This peer-to-peer sensing embodiment could also be used to enhance or create new ways of game play altogether. As such, a system including multiple toys having control devices with peer-to-peer sensing functionality is envisioned among the embodiments described herein. Another embodiment can include a system of toys or devices that are components in an electronic game of tag. The toys can activate and deactivate using the peer-to-peer sensing functionality of the toys, the aim being that the child wins when he/she successfully picks up the toy that is activated.

In some embodiments, location sensing/boundary assignment (similar to the peer-to-peer embodiment) can be included in system 100. For example, receivers, through communication with another battery, a series of batteries or a central hub, can be assigned operational rules based on the distance between the control device 120 and an adjacent control device (distance, or proximity, can be inferred by signal strength in this context). For instance, a maximum distance rule can be established between one receiver relative to another receiver. If the maximum distance between the receiver 124 and the battery-powered device 130 is exceeded, the control device 120 can stop providing power (or control functionality, in general) to the battery-powered device 130.

In some embodiments, proximity alarms can be included in system 100. The system can send or initiate an alert when a child, pet or person moves further than a designated distance from the control device 120 and/or controller 110. For example, the alert can be sent to a smart phone that is configured as the controller described herein and the child, pet or person moving can be in possession of the battery-powered device 130 that includes or is communicatively coupled to the control device 120. In some embodiments, the control device 120 could as such function as a standalone device without needing to be installed in a battery-powered device 130. The foregoing is merely one exemplary embodiment of the control device 120 operating as a standalone device that is not installed in a battery-powered device 130. In various other embodiments, the control device 120 can operate as a standalone device not installed in the battery-powered device 130. In these embodiments, the control device 120 can perform one or more functions described herein.

In some embodiments, the receiver 124 of the control device 120 can constantly, (or periodically or intermittently) monitor for a valid signal from a transmitter 112 at the controller 110 to transmit a signal (e.g., signal 140) that an on-state is desired for the battery-powered device 130. For example, the battery-powered device 130 can be de-activated and such constant or intermittent monitoring can be desired at the controller 110. This of course can place further drain on the controller 110 power and/or reduce the life expectancy of the controller power supply. Therefore, the implementation of a motion switch can be employed to provide another feedback signal to the logic circuitry to aid in additional power saving schemes. An example of this can be that upon being “killed” (e.g., powered down), the battery-powered device 130 can be shaken, triggering the motion switch to power the receiver 124 at the control device 120 on for some predetermined amount of time. This window of time during which the control device 120 is powered on can allow for a brief period whereby the control device 120 can receive, from the transmitter 112 at the controller 110, the control signal 142 including information configured to cause the control device 120 to switch the battery-powered device 130 on.

In one embodiment, for example, this function can allow a parent to re-activate a toy that has been de-activated (e.g., put to sleep) for, say, a 12 hour interval (or any other period of time, which can be pre-programmed or dynamically updated/programmed). To turn the toy back on, a child can shake the toy (and thus the control device 120 inside the toy) to awaken the receive function of the control device 120. The parent then has a window of time to use the controller 110 to turn the toy back on. Otherwise, the control device 120 doesn't switch the toy back on, and the toy remains asleep until the 12 hour timer times out. To avoid the nuisance for a parent to figure out which toys are off and which are not off, the toy can return to the original on state passively as described above. As such, in some embodiments, picking up the toy can activate the motion switch that re-activates the toy to an on state.

In various embodiments, when the battery-powered device 130 is inactive, the control device 120 does not turn off the battery-powered device 130. Instead, the level of the intermittent current draw by the battery-powered device can be utilized to signal the receiver 124 of the control device 120 to wake up in the event of certain events at the battery-powered device 130. For example, the receiver 124 of the control device 120 can be awakened if the battery-powered device 130 begins to draw a predetermined amount of current from the battery of the battery-powered device 130. In some embodiments, the current sensing function of the control device can activate upon detection of a current draw in excess of approximately 10 milliamps.

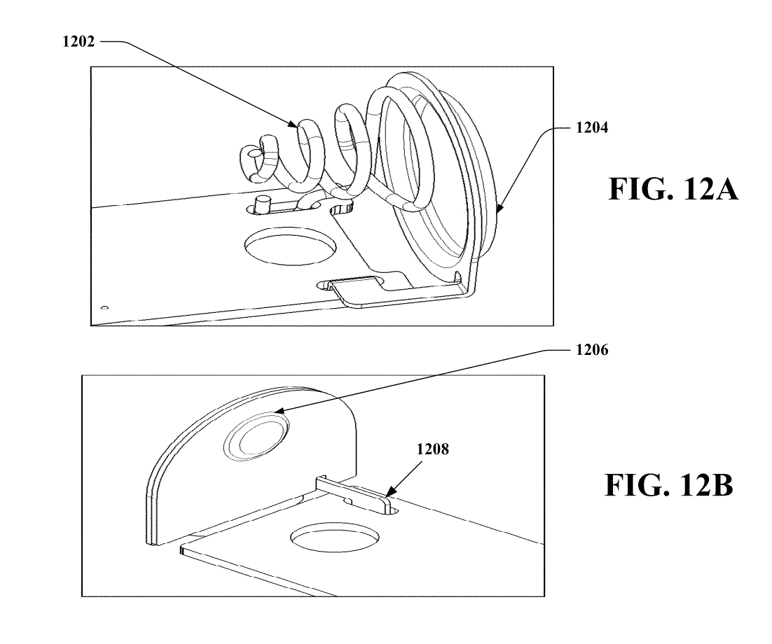

Upon activation of the receiver 124 of the control device 120 from such a current drain, the receiver 124 could enter a receive mode, ready to receive a kill command. This function could be made possible through the combination of a current sensing resistor (e.g., current sensing resistor 1216 described herein with reference to FIG. 12) coupled to a low current draw operational amplifier comparator (e.g., operational amplifier/current and voltage sensing circuitry 204 described with reference to FIG. 2) capable of detecting the voltage drop arising from a minimum threshold current flow across the current sense resistor (ideally a low ohmic value component to minimize voltage drops and maintain the proper function of the battery-powered device).

In some embodiments, the systems described herein can enable a parent to deactivate or silence a toy (or other battery-powered device) being played with by a child. The current draw and/or the motion of the toy can lead to activation of the receiver circuitry at the control device 120, and a signal from the transmitter 112 of the controller 110 can cause the control device to switch off the toy or battery-powered device 130.

In some embodiments, the child can be holding the toy that has been deactivated and a parent may wish to reactivate the toy. The motion of the toy can create one of two inputs to an equivalent AND logic gate. The second input possible can be an ON command from the receiver of the control device. Both the motion input signal and/or the ON command from the receiver can signal the toy to activate by powering on the main load transistor.

In some embodiments, a child can be playing with a toy and a parent can deactivate the toy via the controller controlling the control device (e.g., control device 120, 200) to perform the deactivation. The child can put down the toy and after a prescribed period of time (e.g., 12 hours—for example, with the 12HT 408 of FIG. 4), the toy can reactivate once picked up (the motion switch can signal the toy to turn on). A switch that deactivates the toy that keeps the toy deactivated can be nuisance for parents that then have to remember to turn on the deactivated toy (and convenience is therefore lost). As such, a system that automatically reactivates the toy is advantageous and distinct from conventional control devices.

In some embodiments, the toy spontaneously activates (when the toy falls, is bumped, or otherwise switches itself on following a 12 hour “sleep cycle”). In these cases, current sensing circuitry (e.g., current sensing resistor 1216 described herein with reference to FIG. 12 and/or the operational amplifier/current and voltage sensing circuitry 204 described with reference to FIG. 2) can detect the current drain via the comparator/current sensing resistor system, switch on the short duration timer and receiver circuitry, and an opportunity to switch off the toy is made available to the operator holding the transmitter. In some embodiments, the control device 120 can turn the current sensing circuitry off to conserve power.

Similar uses and advantages to those described above and throughout can be obtained through control of any number of different battery-powered devices both inside and outside of the home. In effect, control can be made of any battery-powered device having a circuit to which the control device can be connected. In various embodiments, the need to manually depress or otherwise physically manipulate an on/off switch at the battery-powered device to turn the battery-powered device on or off at the site of the battery-powered device is eliminated. Further, the advantages of using RF signals for communication between the controller 110 and the control device 120 provide the capability for a host of RF devices to be employed as the controller in the embodiments described herein.

While the embodiments described above include a controller 110 that communicates a control signal 142 to cause the control device 120 to perform one or more operations that control the battery-powered device 130 to operate in a specified manner (or cause the control device 120 to operate in a specified manner), in some embodiments, the control device 120 can perform operations and/or control the battery-powered device 130 without receiving a control signal 142 from the controller 110.

For example, the control device 120 can detect motion of the battery-powered device 130, and initiate control of the battery-powered device 130. For example, the control device 120 can initiate control of the battery-powered device 130 to cause the battery-powered device 130 to perform any number of operations by generating and outputting signals to the battery-powered device 130 from a microcontroller in the control device 120. The operations can be activation, de-activation, activation upon motion sensing of the battery-powered device 130, activation or de-activation upon a determined amount of time passing since motion was detected or the like.

As other examples, the control device 120 can cause one or more operations to be performed at the battery-powered device 130 based, at least, on temperature (e.g., sensed via temperature sensor 210 described herein with reference to FIG. 2), current sensing (e.g., sensed via current sensing resistor 1216 described herein with reference to FIG. 12 and/or the operational amplifier/current and voltage sensing circuitry 204 described with reference to FIG. 2) or other sensing associated with operations of the battery-powered device relative to the environment in which the battery-powered device (e.g., battery-powered device 130) is located.

FIG. 2 is a block diagram illustrating an exemplary system including a control device configured to control battery-powered devices. In some embodiments, the structure and/or functionality of control device 200 can be provided in control device 120 (or vice versa).

Control device 200 can include an N-channel metal oxide semiconductor field effect transistor (MOSFET) 202, an operational amplifier/current and voltage sensing circuitry 204, boost converter 206, a microcontroller 208, a temperature sensor 210, an accelerometer 212, a clock 216 and/or antenna 214 and/or battery 220.

While not shown, in some embodiments, the control device 200 can include a P-channel MOSFET in lieu of the N-channel MOSFET 202. In the instant embodiment shown, the N-channel MOSFET 202 connects to the negative terminal of the battery-powered device while the battery 220 connects to the positive terminal of the battery-powered device.

In embodiments employing a P-channel MOSFET in lieu of the N-channel MOSFET 202, the connection from the P-channel MOSFET to the battery-powered device would connect to the positive terminal of the battery-powered device while the battery 220 would connect to the negative terminal of the battery-powered device.

The antenna 214 can enable a wireless (e.g., BLUETOOTH®) communication channel between the controller (e.g., controller 110 of FIG. 1) and the control device 200. In some embodiments, the antenna 214 can include a balun transformer.

In some embodiments, the antenna 214 can receive an RF signal as an input to the control device 200. In some embodiments, the RF signal is a BLUETOOTH® signal that can be read by the microcontroller 208 in embodiments wherein the microcontroller 208 includes or is a BLUETOOTH® low energy microcontroller running firmware, but need not be so.

In various different embodiments, the signal can include a family identification, device name, device switch (e.g., on or off) and/or Wirth syntax notation timer values. In some embodiments, a string of information can be entered that sets an on/off timer and/or that sets a sleep/awake timer.

For example, in various embodiments, the syntax can include information for dictating the operation of an on timer (e.g., how long should the battery-powered device 130 be turned on), off timer (e.g., how long should the battery-powered device 130 be turned off), sleep timer (e.g., how long should the transmitter poll off (e.g., transmitter 122 described with reference to FIG. 1)), awake timer (e.g., how long should the transmitter poll on), acceleration limit (e.g., amount of acceleration that, if exceeded, battery-powered device 130 should be turned off) and/or an assignment of 0 (off) or 1 (on) of the wake on shake feature.

In one example, a string of the following “1*([10/10]): can turn the battery-powered device on for 10 seconds and then off for 10 seconds and repeat over and over again. As another example, a string of “1*([4*([5/5])/10])” can turn the battery-powered device on for 5 seconds and then turn off for 5 seconds and repeat four times, then turn the battery-powered device off for an additional 10 seconds and then repeat over and over again. Any combination of timer on/off (or sleep/awake) operations can be dictated by a text string that can be transmitted to the control device.

In some embodiments, the value of the wake on shake feature can be 0 (default, off) or 1 (on). If on, the battery-powered device 130 will not be turned on by the control device 120 when the sleep timer elapses unless the battery-powered device is shaken (and the control device 120 detects the motion).

The antenna 214 can output various microcontroller 208 encoded RF signals. The information can be output as the signal 140 of FIG. 1 in some embodiments. The information can include, but is not limited to, temperature sensed of the battery-powered device or the control device 200, voltage sensed by the voltage sensing circuitry of the operational amplifier/current and voltage sensing circuitry 204, the current sensed by the current sensing circuitry of the operational amplifier/current and voltage sensing circuitry 204, whether the awake on shake feature is turned on or off (e.g., whether the battery-powered device will be controlled to be activated upon detected motion/acceleration of the device), the acceleration value at which the battery-powered device will be activated, the state of the battery-powered device (e.g., whether the battery-powered device is currently turned on or turned off) and/or the state/remaining time of any number of internal timers. The internal timers can include, but are not limited to, an on timer, off timer, sleep timer and/or awake timer.

The remaining time associated with the on timer can be an indicator of how long the battery-powered device will remain on. The remaining time associated with the off timer can be an indicator of how long the battery-powered device will remain off The remaining time associated with the sleep timer can be an indicator of how long the transmitter of the control device 200 will poll off The remaining time associated with the awake timer can be an indicator of how long the transmitter of the control device 200 will poll on.

Turning now to the microcontroller 208, the microcontroller 208 can include functionality for outputting information that causes the control of the operations of the battery-powered device. For example, in some embodiments, the microcontroller 208 can process one or more instructions (received from the controller or internally-generated at the control device 200) for causing operations to be performed by the battery-powered device to which the control device 200 is operably coupled.

The microcontroller 208 can decipher the signal (e.g., control signal 142 of FIG. 1) received at the control device 200. In some embodiments, the control signal can include attributes (e.g., activate, de-activate, wake on shake) for the manner of controlling the battery-powered device. Employing the firmware of the microcontroller 208, the microcontroller 208 can update attributes and/or generate particular voltage output to the N-channel MOSFET 202 to open or close the switch embodied as the N-channel MOSFET 202.

In some embodiments, the microcontroller 208 can output one or more signals for controlling the operation of the battery-powered device 130. For example, the positive terminal of the battery 220 can be communicatively coupled to a battery of the battery-powered device. In these embodiments, to power the battery-powered device with a single battery 220, the battery 220 can be connected or disconnected from the battery-powered device via the N-channel MOSFET 202. When the battery 220 is connected, the battery-powered device can be powered on, and when the battery 220 is disconnected, the battery-powered device can be powered off

As another example, the microcontroller 208 can employ internal resistor capacitor timers that can control one or more different operations of the battery-powered device 130.

In some embodiments, the microcontroller 208 can be a BLUETOOTH® low-energy microcontroller running firmware. To maintain the firmware as simple as possible, in some embodiments, most of the operations for controlling the battery-powered device can be offloaded onto the controller (e.g., controller 110 of FIG. 1) (whether a mobile or standalone key fob). In some embodiments, the microcontroller 208 can have four programmable timers, report four pieces of data, have one active function (ON/OFF) and one limit. The design of this firmware can be such that almost any other future feature can be implemented on the controller 110 using this device firmware.

The N-channel MOSFET 202 can be a switch that connects or disconnects the load of the battery-powered device from the battery 220 of the control device 200. In these embodiments, the output from the battery 220 can be an input to the N-channel MOSFET 202.

For example, in some embodiments, the N-channel MOSFET 202 can receive a voltage signal from the microcontroller 208 in the form of a high or low voltage. If the voltage is high, the gate of the N-channel MOSFET 202 closes and the N-channel MOSFET 202 acts as a closed switch, allowing current to flow from the battery 220 to the battery-powered device. If the voltage is low, then the gate of the N-channel MOSFET 202 opens and no current can flow from the battery 220 of the control device 200 to the battery-powered device.

In various embodiments, the battery 220 can supply all or a portion of the power required by the components of the control device 120.

For example, in some embodiments, the battery 220 within the control device 120 can supply the entirety of the power required by the control device 200. For example, the battery 220 can output 1.5 V to the boost converter 206 that can be upconverted to 3V. The 3V can be employed by the control device 200 to power the components of the control device 200.

In some of these embodiments, the battery 220 can also supply all or at least a portion of the power to the battery-powered device. For example, the battery 220 can be a 1.5V AAA battery in some embodiments. As shown in FIG. 2, the battery 220 can be connected to or disconnected from the battery-powered device via the N-channel MOSFET 202 to cause the battery-powered device to power on or off, respectively.

For a battery-powered device requiring one AA battery (e.g., a key chain flashlight), the AA battery of the battery-powered device can be replaced by the control device 200 (which includes battery 220). The light of the key chain flashlight can then receive all necessary power from the battery 220 of the control device 200. In some embodiments, the control device 200 can concurrently parasitically draw from the battery 220 as well for operation of the control device 200.

In some embodiments, the battery-powered device can have one or more additional batteries (other than battery 220) from which power to the battery-powered device is obtained. The additional batteries can be electrically connected in series with the battery 220 if the battery-powered device 130 requires more power than that provided by an AAA battery. For example, in a battery-powered device 130 that would generally require 3 AA batteries for operation, one of the 3 AA batteries can be replaced with the control device 120 (which includes battery 220). In this embodiment, a portion of the power for the battery-powered device 130 can be received from the battery 220 associated with the control unit. The battery-powered device would then essentially have a battery pack composed of two 1.5V AA batteries and effectively one 1.5V AAA, all arranged in series.

In either embodiment (with or without additional batteries), one or more of the components of the control device 200 can decouple the additional batteries from the battery 220. For example, one or more of the components of the control device 200 can decouple an AA equivalent terminal from the battery 220 (which can be an AAA battery in some embodiments), and thus open the circuit that would typically supply power to the battery-powered device 130 from the control device 120. The electronics within the control device 120 can, however, remain coupled to the battery 220 and therefore continue to draw power to maintain the communication channel between the controller 110 and the control device 120. The channel can be maintained in an active state either continuously or intermittently in various embodiments.

In some embodiments, in lieu of coupling the battery 220 in series with additional batteries of the battery-powered device, the battery 220 can be electrically isolated from the battery pack of the battery-powered device. In this embodiment, for example, a 3V lithium cell can be employed for the control device 120, and a separate 1.5V N-size cell can be employed for the power supply of the battery-powered device 130.

In some embodiments, the control device 120 can receive some of the power necessary for operation of the control device 120 from a battery associated with the battery-powered device 130 and some of the power necessary for operation from a battery within the control device 120. For example, a 1.5V button cell in the control device 120 can be electrically coupled in series with a 1.5V N-size battery outside the control device 120 and within the battery-powered device 130. The button cell can be 3V, or 1.5V to be in series with the larger 1.5V cell to obtain 3V.

Thus, 3V can be achieved for use by the control device 120. In this embodiment, the 3V can be obtained from having the 1.5V button cell in series with the 1.5V N-size cell, but the supply to the external terminals of the control device 120 can be received from the N-cell only in some embodiments, and thus supply 1.5V to the battery-powered device. Accordingly, in some embodiments, only the 1.5V N-size battery is utilized for the power supplied to the battery-powered device 130. Accordingly, in this embodiment, the control device 120 can receive some of the power for operation of the control device 120 from a battery associated with the battery-powered device 130 (and some of the power for operation from the smaller button cell).

As described above, the battery-powered device can be totally or partially powered by the battery 220 of the control device 200.

The boost converter 206 can upconvert the voltage from the battery 220 of the battery-powered device to a voltage required by the control device 200 (or required by one or more components of the control device 200). For example, in the case wherein the battery-powered device is utilizing an AAA battery for powering, the boost converter 206 can convert the approximate 1.5 V from the AAA to approximately 3V to power the control device (or one or more components thereof). For example, the 3V can be employed to power the microcontroller 208 and/or accelerometer 212 and/or the operational amplifier/current and voltage sensing circuitry 204 of the control device 200.

The accelerometer 212 can sense the acceleration of the battery-powered device. For example, the battery-powered device can be moved and experience an acceleration. The control device 200 can cause the battery-powered device to perform one or more operations based on the sensed motion. In some embodiments, the control device 200 can transmit a signal (e.g., signal 140 of FIG. 1) to the controller (e.g., controller 110 of FIG. 1) and receive a control signal (e.g., control signal 142 of FIG. 1) in response to the sensed motion. In some embodiments, the control device 200 can turn the accelerometer 212 off to conserve power.

The operational amplifier/current and voltage sensing circuitry 204 can amplify the voltage read across the current sensing resistor (that varies with the applied load and current draw) and supply that voltage to the microcontroller 208. In various embodiments, a voltage signal can be output from the operation amplifier portion of the operational amplifier/current and voltage sensing circuitry 204. The signal can be a signal read and amplified from the current passing through the current sensing resistor due to load from the external, battery-powered device 130.

In some embodiments, the control device 200 can be sensitive from 0 to 4 amps (A) in increments of 1 milliamps (mA) with a root mean square (RMS) noise figure of approximately 1 mA. Therefore, a wake-up based on sensed motion can be triggered upon a reading of 3 mA by the battery-powered device by the current sensing circuitry of the operational amplifier/current and voltage sensing circuitry 204.

The microcontroller 208 can digitize the voltage from the operational amplifier/current and voltage sensing circuitry 204 and determine how much current is flowing though the resistor of a known resistance value. Since it is desirable to have high sensitivity to low current draws, in some embodiments, this signal can be amplified by the operational amplifier portion of the operational amplifier/current and voltage sensing circuitry 204.

The current and voltage sensing circuitry of the operational amplifier/current and voltage sensing circuitry 204 can allow for certain behaviors to be possible. By way of example, but not limitation, the control device 200 can report the voltage of the battery 220 in a manner that correlates to known battery life versus voltage curves. In this embodiment, a user can have a prediction of how much battery life remains in the control device 200.

Current sensing can be performed by the current sensing circuitry of the operational amplifier/current and voltage sensing circuitry 204 for devices that are used in a stationary sense. For example, the current sensing can be employed for a stationary battery-powered device (e.g., a battery-powered learning table or activity center). In this embodiment, the control device 200 may not be continuously moved from one position to another, and the accelerometer may not be providing an “in-use, or in-motion” feedback signal to the control device 200). The current sensing circuitry, however, can report that the battery-powered device is in use, and thus keep the control device 200 in a mode of operation that allows the controller (e.g., controller 110 of FIG. 1) to communicate with the control device 200 and power the control device 200 off, rather than the control device 200 going into a sleep mode.

A temperature sensor 210 can be included in the control device 120. In some embodiments, the temperature sensor 210 is included as a built-in sensor of the microcontroller 208 but need not be so. In some embodiments, the temperature sensor 210 can sense the temperature of the battery-powered device or the control device 200. In some embodiments, the control device 200 can transmit information indicative of the sensed temperature. As such, the temperature sensor 210 can enable the control device 200 to output a signal (e.g., signal 140) informing the controller 110 of overheating, fire in the geographical region of the battery-powered device or the like. For example, if a temperature threshold is crossed, the control device 200 can enter a mode in which the control device 200 broadcasts a continual alert of extreme temperature in the home in which the battery-powered device is located.

The clock 216 can perform clock signal functions for the operation of the components of the microcontroller 208 and/or other components of the control device 120. In some embodiments, the clock 216 can be or include a crystal oscillator.

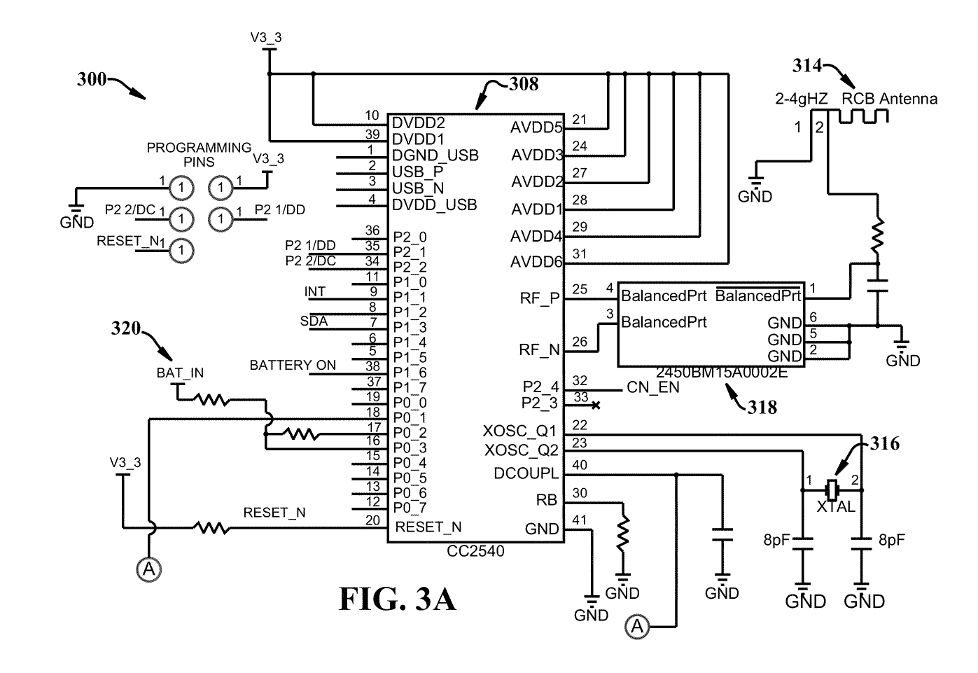

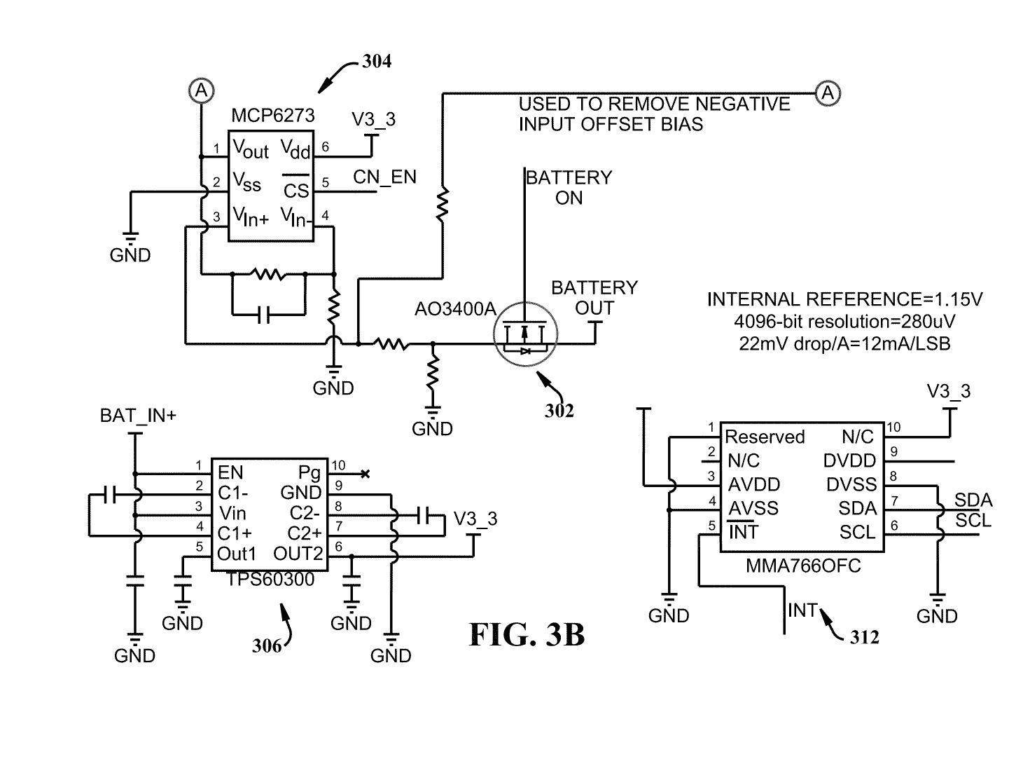

FIG. 3 is a circuit diagram illustrating an exemplary control device including a control device configured to control battery-powered devices. In various embodiments, one or more of the structure and/or functionality of the control device 300 can be or include the structure and/or functionality of control device 120, 200 (or vice versa).

As shown, the circuit of the control device 300 can include a N-channel MOSFET 302, an operational amplifier/current and voltage sensing circuitry (OACVS circuitry) 304, boost converter 306, a microcontroller 308, an accelerometer 312, an antenna 314, clock (e.g., crystal oscillator) 316 and/or battery 320. In various embodiments, the N-channel MOSFET 302, OACVS circuitry 304, boost converter 306, microcontroller 308, accelerometer 312, antenna 314, clock (e.g., crystal oscillator) 316 and battery 320 can include the structure and/or functionality of the N-channel MOSFET 202, OACVS circuitry 204, boost converter 206, microcontroller 208, accelerometer 212, antenna 214 and/or battery 220, respectively. In some embodiments, the circuit can also include a balun transformer 318 as part of the antenna 314. Further, in some embodiments, the components of the circuit of control device 300 can be connected as shown in some embodiments.

FIG. 4 is a block diagram illustrating an exemplary non-limiting embodiment of a circuit of a receiver for a control device configured to control battery-powered devices. The circuit 400 can be, or be included in, the control device described with reference to FIG. 1. For example, the receiver can be receiver 124 of FIG. 1.

In the embodiment shown, the circuit 400 can include a motion switch (MS) 402, current sensing comparator circuit (CS) 404, first timer (5MT) 406, second timer (12HT) 408, a first transistor (Q1) 410, a second transistor (Q2) 412, a transceiver/MCU (Rx) 414, an OR logical gate 416, a NOR logical gate 418 and/or an AND logical gate 420. The components of the circuit 400 can be electrically connected as shown in FIG. 4 in some embodiments.

The MS 402 can be maintained in an open position by default and can close when motion and/or acceleration of the battery-powered device is detected at a level greater than or equal to approximately 0.1G or another predetermined threshold acceleration. The MS 402 (e.g., accelerometer 212 of FIG. 2 in some embodiments) can employ multiple axes (X, Y, Z) for allowing further fidelity on particular motions of the device and the forms of input they generate to the microprocessor (e.g., microcontroller 208) for the control device (e.g., control device 120, 200). For example, in some embodiments, the accelerometer can be a 3-axis accelerometer (e.g., 3-axis accelerometer of FIG. 12). The fidelity of the motion input can provide functionality for effecting particular operational modes, or states, of the control device (e.g., control device 120, 200).

The CS 404 can sense a current draw via a potential change across a low ohm current sensing resistor (e.g., current sensing resistor of FIG. 12).

The 5MT 406 can be a five minute timer. The 5MT 406 can supply power to downstream elements (e.g., Q2 412, AND 420, Q1410, RX 414, NOR 418, 12HT 408, NOR 418) for five minute intervals, resetting continually as long as the logical input to the 5MT 406 is high. The output can be low once five minutes expires from receipt of last V+ input signal.

The 12HT 408 can be a 12 hour timer configured to perform a 12 hour countdown that begins upon receipt of a signal voltage. V_{OUT} can be high until the 12HT time period expires and, after expiration, V_{OUT} can be low.

Q1 410 can be a main load transistor. In some embodiments, the control device can include the main load transistor for switching the main electrical loads passing through the device (e.g. the current supplied to the toy can be switched on or off by an electrical component). In another embodiment, one such device is a relay, however, relays employ electromagnets that consume a fairly large current relative to the current draw of the toy (or battery-powered device 130) in the context of this invention. Therefore, the control device can use the main load transistor to electrically couple the AAA battery to the external battery contacts of the AA form factor housing (or equivalent respective battery/form factor of interest).

Q2 412 can be a second transistor and can be configured to switch the receiver of the control device on.

The transceiver/MCU (Rx) 414 can operate with 90 μAH and 5% duty cycle. While the RX is described as a transceiver/MCU combination, in some embodiments, the RX can be a standalone transceiver.

In various embodiments, the OR 416, NOR 418 and AND 420 logic gates can be complementary metal oxide semiconductor (CMOS) logic gates.

In some embodiments, the RF circuit of the control device (e.g., control device 120 of FIG. 1 or control device 200 of FIG. 2) can be designed with very low quiescent power consumption. For example, available RF integrated circuits (ICs) typically have a benchmark of 90 microamps (μA) using battery saving schemes involving sleep/wake/polling cycles to reduce the duty cycle on the circuitry for the receiver (e.g., receiver 124). Further, embodiments can involve chips that supply dual clock oscillators that save current by waking up to check for an incoming signal at approximately 868 Megahertz (MHz), then sleep at a greatly reduced clock cycle, say 27 MHz (thus minimizing current drain).

While it is possible to construct a control device in the volume of a standard battery form factor/housing (e.g., housing 928 of FIG. 9A), the available RF ICs typically require a supply voltage in excess of 1.5V (the typical voltage for common single cell alkaline battery form factor/housings). As such, a separate power supply can be employed to power the RF circuitry (e.g., one or more of the components discussed herein with reference to FIG. 3), or special circuitry (e.g., boost converter 206) to raise the voltage from the primary battery (i.e. via a charge pump or boost converter) is employed. In some embodiments, the RF circuitry of the control device can be designed such that the battery life for the control device meets or exceeds the expected life of the battery life typically associated with use for solely powering the battery-powered device.

While the above description of the receiver includes the components shown in FIG. 4, such components are merely exemplary. For example, while the embodiment shown includes the above-listed components, in some embodiments, each of the above-listed components need not be included in the circuit and/or other values can be modified and the modification maintained within the scope of the invention.

By way of example, but not limitation, in other embodiments (not shown), for example, the circuit can include a motion sensing element (e.g., motion switch 402 or accelerometer 212), a current sensing element (e.g., operational amplifier/current and voltage sensing circuitry 204) and/or a main load switch (e.g., N-channel MOSFET 202). Other functions of the circuit (e.g., timing, logic, activation of the transceiver) can be handled by an integrated microprocessor (e.g., microcontroller 208), transmitter (e.g., transmitter 122) and/or receiver (e.g., receiver 124).

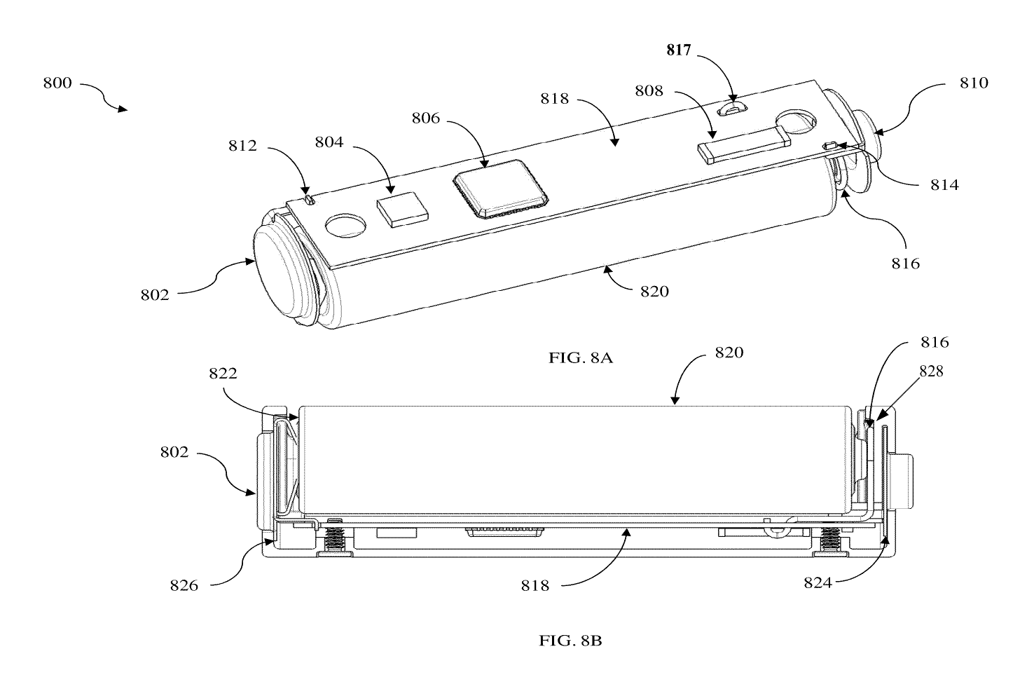

In some embodiments, it may be possible to reduce all of the electronics in the control device in size (using an Application-Specific Integrated Circuit (ASIC)) such that the control device fits in the cap of a normal alkaline or rechargable battery, with the antenna (e.g., antenna 808 described herein with reference to FIG. 8A) of the control device printed on the label.

For example, in some embodiments, an ASIC embodiment of the system can be provided wherein the circuitry (e.g., RF circuitry) (or some variation of one or more components of the circuitry) is reduced in size and embedded to package in the form of an electrochemical cell (e.g., alkaline, nickel metal hydride (NiMH), lithium ion (Li-Ion), lithium ion polymer (Li—Po), or other chemistry form) with an antenna integrally printed on, beneath, or integral to the device label. As such, more of the available cell volume can be employed for the storage of chemical potential energy, thus yielding a higher energy density control device.

In some embodiments, shrinking the volume of the circuitry further via an ASIC can have enable an AAA form factor version of this device to be constructed (that could be powered via an AAAA cell). To achieve such small packaging for the housing (e.g. an AAA form factor), an ASIC can be advantageously incorporated. In some embodiments, the ASIC can utilize available RFICs.

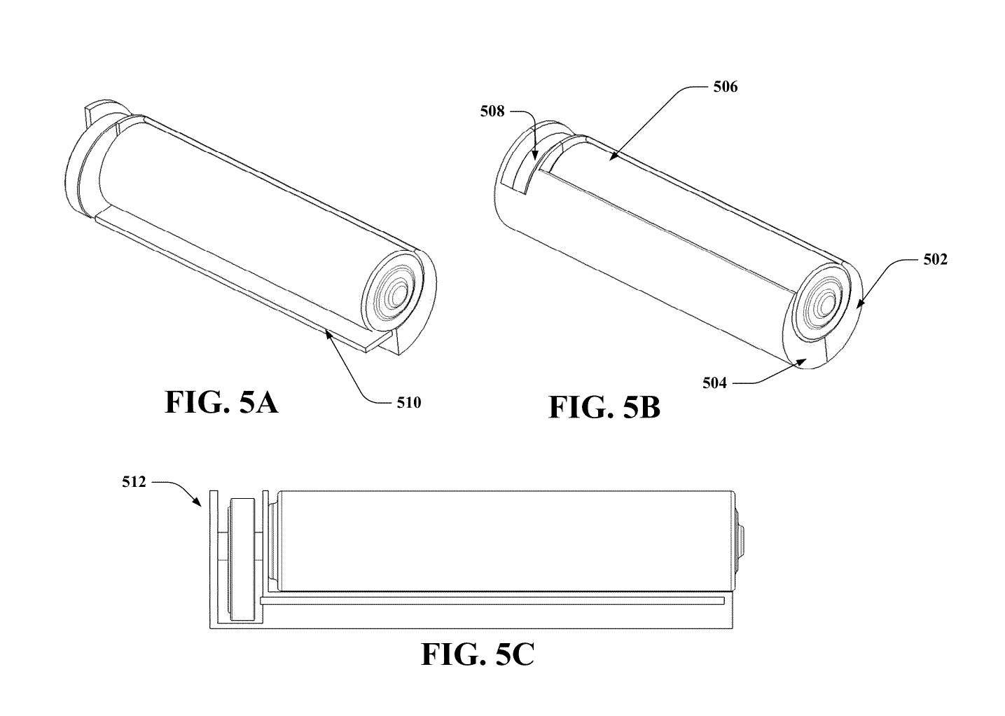

FIGS. 5A, 5B, 5C, 6A, 6B, 7A, 7B and 7C are schematic diagrams illustrating exemplary non-limiting embodiments of systems for controlling battery-powered devices. Each of FIGS. 5A, 5B, 5C, 6A, 6B, 7A, 7B and 7C illustrate views including the components at the control device of the system described with reference to FIGS. 1, 2 and 3.

FIG. 5A illustrates a first view of the first system for controlling battery-powered devices. The first system includes a housing including a right clamshell 502 and a left clamshell 504, a battery 506 (e.g., AAA battery) configured to power the control device (and, in some embodiments, the battery-powered device), and a button cell 508.

FIGS. 5B and 5C illustrate second and third views of the first system. As shown, the RF transceiver/electronics board 510 and terminals (the negative terminal 512 is expressly indicated in the drawings). In various embodiments, the RF transceiver/electronics board can be a board that includes one or more of the components of the control device 120, 200, 300. As such, the RF transceiver/electronics board 510 can be included in the control device described with reference to FIGS. 1, 2 and 3.

The RF transceiver/electronics board 510 can be powered by the battery 506 that is also configured to power the battery-powered device, which in the embodiment shown, is the AAA battery (although any number of different types of batteries can be employed within the housing to power the battery-powered device and/or the RF transceiver/electronics board 510).

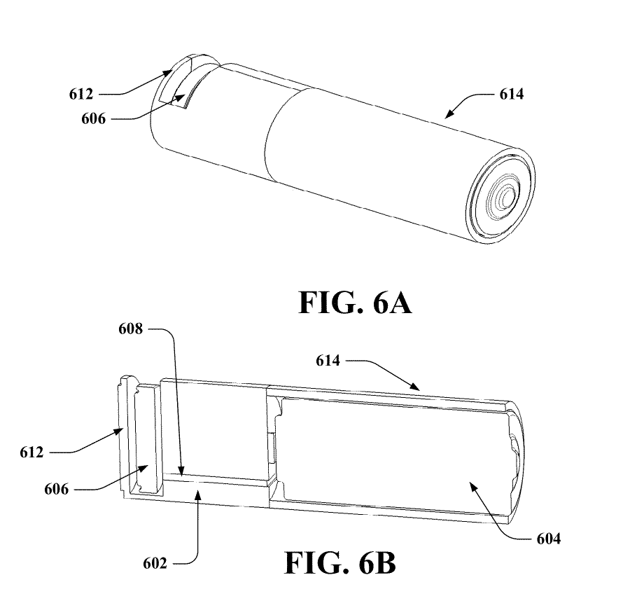

FIGS. 6A and 6B illustrate two views of a second system for controlling battery-powered devices. The first view is shown at FIG. 6A, and the second view is shown at FIG. 6B. The components shown in FIG. 6A and FIG. 6B are identical and the figures merely reflect different views of the second system (where FIG. 6B reflects the view with a portion of the housing 602 cut away for clarity).

The components of the second system will now be described in greater detail with reference to FIG. 6B. FIG. 6B can include a housing 602, a battery 604 (e.g., N battery) configured to partially power the control device, a button cell 606 configured to partially power the control device, an RF transceiver/electronics board 608, battery terminals 610, 612 and a support 614. In various embodiments, the RF transceiver/electronics board 608 can be a board that includes one or more of the components of the control device 120, 200, 300. The RF transceiver/electronics board 608 can be included in the control device described with reference to FIG. 1. The RF transceiver/electronics board 608 can be powered by the battery 604 that is also configured to power the control device (and, in some embodiments, the battery-powered device). In the embodiment shown, the battery 604 is an N battery (although any number of different types of batteries can be employed within the housing 602 to power the RF transceiver/electronics board 608 of the control unit and/or the battery-powered device).

In some embodiments, the button cell 606 can be electrically coupled in series with the N-size battery 604 to power the control device (and to power the battery-powered device in some embodiments).

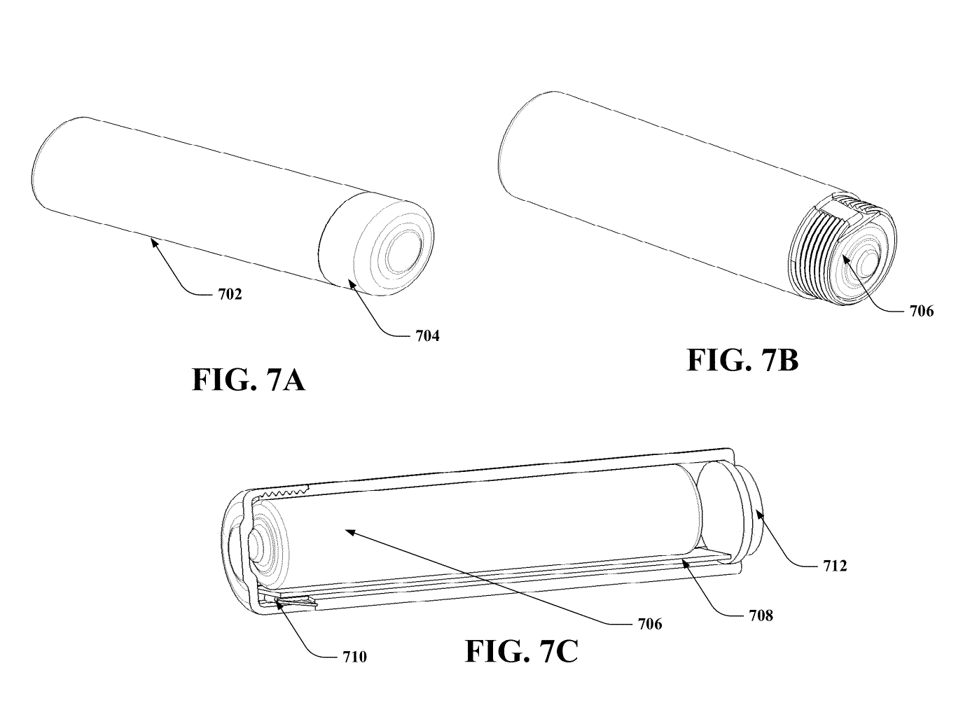

FIGS. 7A, 7B and 7C illustrate three views of a third system for controlling battery-powered devices. The first view is shown at FIG. 7A and can include an exterior casing (i.e., housing) 702 and battery terminal/cap 704 (while a threaded cap is shown, other caps are also possible and envisaged) and a spring connector 710.

The second view is shown at FIG. 7B and can include a battery 706 configured to power the control device and/or battery-powered device (e.g., AAA battery). The third view is shown at FIG. 7C and can include an RF transceiver/electronics board 708 and two battery terminals (one of which is shown at 712). In various embodiments, the RF transceiver/electronics board 708 can be a board that includes one or more of the components of the control device 120, 200, 300. As such, the RF transceiver/electronics board 708 can be included in the control device described with reference to FIGS. 1, 2 and 3. For example, the RF transceiver/electronics board 708 can include one or more of the components of the control device 120, 200, 300.

The RF transceiver/electronics board 708 can be powered by the battery 706, which is also configured to power the control device (and, in some embodiments, to partially or completely power the battery-powered device). In the embodiment shown, the battery 706 is an AAA battery (although any number of different types of batteries can be employed within the exterior casing to power the RF transceiver/electronics board 708 of the control device and/or the battery-powered device).

The exemplary non-limiting embodiments shown may be designed according to one or more of the following specifications. The control device can appear to an end user as an AA battery (or appear as other standard, or non-standard, batteries). As shown in FIGS. 5A, 5B and 5C, the control device can be coupled to a housing large enough to receive an AA battery but that is configured to receive an AAA battery off-center. Specifically, FIG. 5B illustrates the RF/electronic circuitry (e.g., RF/electronic circuitry 400, 126) as powered solely by dedicated button cell with integral clamshell housing to support an AAA battery off-center with the remaining volume of the housing being sized to allow insertion of the electronic board containing the aforementioned elements.

In some embodiments, the BLUETOOTH® low energy chipset can be employed as the chipset includes circuitry that can be powered from a small button cell. In various embodiments, the RF transceiver/electronics board can receive power from the primary battery alone, the button cells and/or a combination of the primary battery and/or the button cell.

The electronics board can be packaged beneath or above the AAA battery. FIGS. 7A, 7B and 7C illustrate a configuration wherein the RF/electronics circuitry can be powered solely by an AAA battery.

Turning back to FIG. 6B, FIG. 6B illustrates the RF/electronic circuitry as powered solely by a dedicated button cell. An N size battery is supported by a support sleeve attached to the housing containing the button cell and electronic circuitry. In this embodiment, the device can be a standalone switching element powered by the button cell. It can be coupled in series to an N size battery that is smaller in diameter than a standard AA battery. The point of the sleeve can be to support the N battery so that the N battery stays coaxial with the switching element (the control unit). The distinction is that the control device in this embodiment can be decoupled from the battery that supplies the battery-powered device 130.

As shown in FIG. 6B, the support sleeve can be connected in series with the battery-powered device (e.g., battery-powered device 130). The two elements (e.g., support sleeve and housing) collectively would form a nominal AA battery form factor/housing/housing. The latter embodiment has the novelty that it is a standalone compact RF switch that could potentially be added to a battery operated device that was designed to have a docking port for this switch.

The circuits can contain slightly different elements with regard to power supply. For instance, in the N cell configuration, the button cell is the sole power source for the RF circuit. The button cell could be 3V lithium, in which case no charge pump or boost convertor would be needed to get the RFIC its 3V supply. The smaller board can be the result of the packaging constraint.

While various embodiments are discussed with reference to FIGS. 5A, 5B, 5C, 6A, 6B, 7A, 7B and 7C other sizes or arrangements are envisaged as within the scope of the embodiments described herein. For example, systems that are sized to accommodate batteries that are larger than AAA and AA, and corresponding different arrangements of cells within the housing (e.g., two or more N batteries in parallel within a C size battery housing for instance).

FIGS. 8A and 8B illustrate views of an embodiment of a system configured to control battery-powered devices. As shown in FIG. 8A, the system 800 can include a battery terminal 802 (e.g., a negative terminal for an AA battery), a sensor 804 that senses motion of a battery-powered device in which the system 800 is included, RF IC/microprocessor 806, antenna 808, and/or a battery terminal 810 (e.g., a positive terminal for the AA battery).

In some embodiments, connection points 812, 814 can represent points of electrical connection between the battery terminals 802, 810 and the integrated circuit board 818 to which the RF IC/microprocessor 806, antenna 808 and sensor 804 are connected.

In some embodiments, connection 817 can represent the point of electrical connection between the IC board 818 and another battery in the system 800 (e.g., an additional battery for providing power to the battery-powered device). In some embodiments, a wire coil 816 can acts as an apparatus to connect the additional battery to the integrated circuit board 818.

FIG. 8B illustrates a battery 820 and a connection point 822 between the battery terminal 802, battery 820 and integrated circuit board 818 are shown. Also shown is the above-referenced wire coil 816, integrated multifunction stamping 824, an integrated multifunction stamping/cantilever spring 826 and an insulation area 828 between the circuit board 818 and integrated multifunction stamping 824. In various embodiments, the housing of FIG. 8B can be made of a non-conducting RF transparent material (e.g., Acrylonitrile-Butadiene-Styrene (ABS) plastic or the like). As such, the insulation area 828 can reduce or prevent the circuit board 818 and integrated multifunction stamping 824 from being in electrical contact with one another. In lieu of such contact, an electrical connection between the N-channel (or P-channel MOSFET of the circuit board 818 and the battery-powered device can be employed for powering the battery-powered device on or off, as discuss with reference to FIGS. 2 and 3.

In one embodiment, the IC board 818 is connectable to the circuitry of the battery-powered device. The IC board 818 can be removable in some embodiments, and non-removable (e.g., directly integrated) in other embodiments. In various embodiments, the IC board 818 is implanted in the body of the battery-powered device. In some embodiments, the functionality, circuitry and/or components described herein can be directly integrated into the circuits of the battery-powered device (e.g., toy).

While the embodiments described herein include a description of an IC board 818 of a receiver being embedded in a form factor/housing of a battery-powered device, in some embodiments, the IC board 818 can be located remote from the battery-powered device. In these embodiments, a wired or wireless channel can exist between the control device having the IC board 818 and the battery-powered device for control of the battery-powered device.

FIGS. 9A and 9B illustrate views of another embodiment of a system configured to control battery-powered devices. FIG. 9B illustrates the embodiment including battery 922 (and showing compressed spring 920) while FIG. 9A includes the embodiment without battery 922 (and showing uncompressed spring 920). Battery terminals 918, 926 couple the battery 922 to the battery-powered device (not shown) external to the housings 928, 930.

In some embodiments, the PCB 924 can include an antenna (which can be a PCB trace) 904, clock (e.g., crystal oscillator) 906, BLUETOOTH® low energy (BLE) microprocessor 908, boost converter 910, N-channel MOSFET 916, three-axis accelerometer 902, operational amplifier 912 and/or current sensing resistor 914. In embodiments, one or more of the antenna 904, clock 906, BLE microprocessor 908, boost converter 910, n-channel MOSFET 916, three-axis accelerometer 902, operational amplifier 912 and/or current sensing resistor 914 can be electrically and/or communicatively coupled to one another to perform one or more functions of the control device.

The housings 928, 930 include two posts (not shown) that pass through and index the PCB 924. The screws 932, 934 pass through holes (not shown) in the covers of the housings 928, 930 and thread into these posts.

With reference to FIGS. 8A, 8B, 9A and 9B, while the circuit board 818 with sensor 804, RFIC/microprocessor 806, antenna 808 shows an embodiment of a housing with a cantilever spring 826, the embodiments of the housings of FIGS. 9A and 9B differ slightly. The embodiments illustrated in FIGS. 8A and 8B employ a P-channel MOSFET (not shown) while the embodiments illustrated in FIGS. 9A and 9B employ an N-channel MOSFET 916. As such, in the embodiments of FIGS. 8A and 8B, ground for the AAA battery can be connected to the external cathode of the AA equivalent enclosure, and the anodes can be connected or disconnected to one another by the P-channel MOSFET. In the coil spring design of FIGS. 9A and 9B, using the N-channel MOSFET 916, the anode of the AAA battery can be common to the anode of the AA form-factor equivalent housing, and the cathodes can be connected or disconnected to one another by the N-channel MOSFET 916.

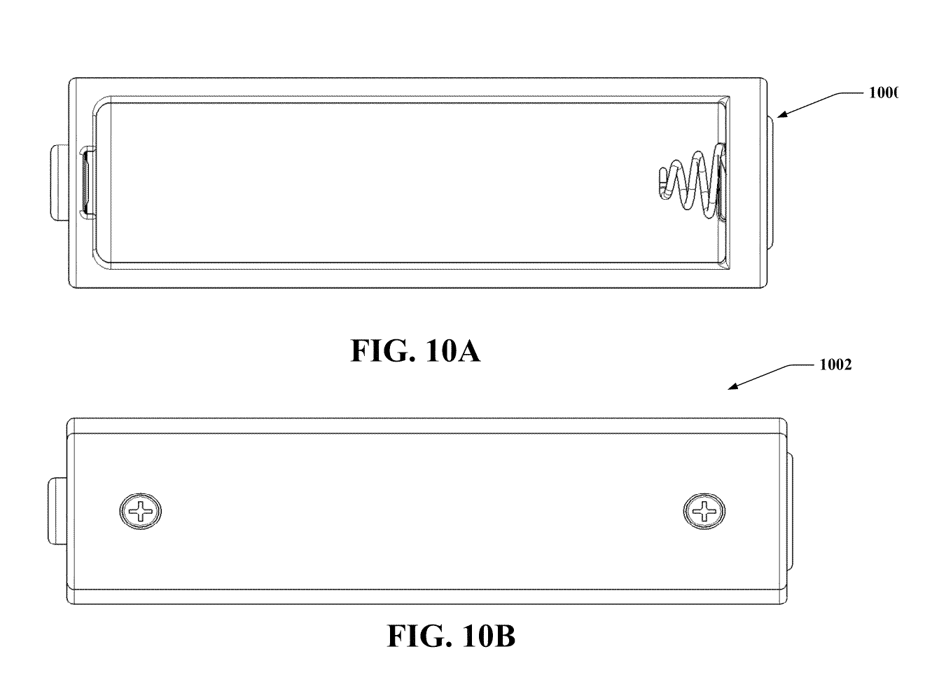

FIGS. 10A and 10B are schematic diagrams illustrating views of a housing for control devices configured to control battery-powered devices. Referring first to FIGS. 10A and 10B, the top 1000 of the housing can be shown at FIG. 10A and the bottom 1002 of the housing can be shown at FIG. 10B. The housing can include a printed circuit board (PCB) on which one or more components of the control device can be formed. A battery that can power the control device can be provided in the housing. In some embodiments, the battery powering the control device can be the same battery providing all or part of the power for the battery-powered device. For example, in some embodiments, a first battery (e.g., AAA battery) can be provided within the housing and the terminals of the housing can couple to a second battery (e.g., AA battery) outside of the housing and employed for powering the battery-powered device. In some embodiments, the housing can be sized to receive AA or other size batteries for powering the control device and/or battery-powered device.

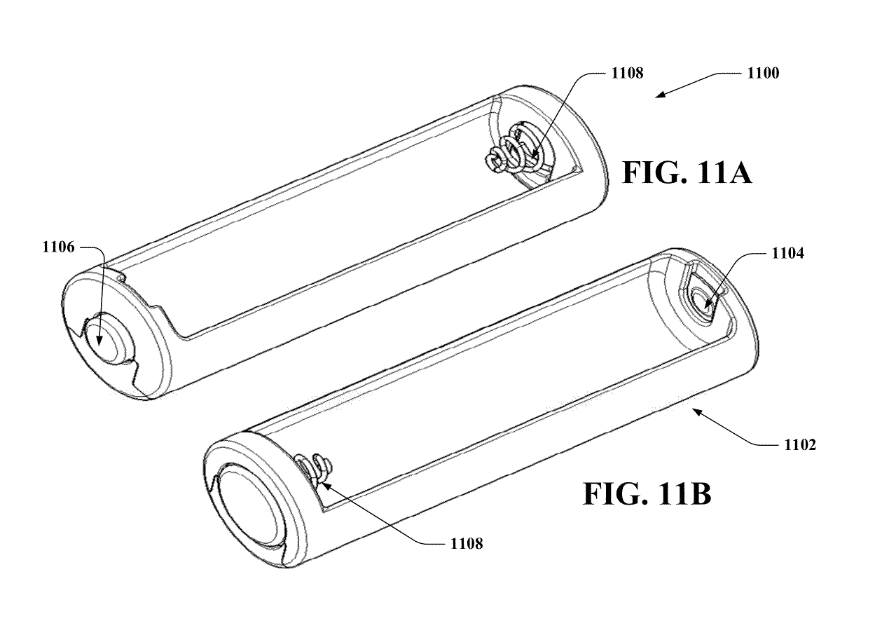

The top and bottom of the housing will be discussed in greater detail with reference to FIGS. 11A and 11B. The housing of FIGS. 10A and 10B can be the same housing of FIGS. 11A and 11B in some embodiments.

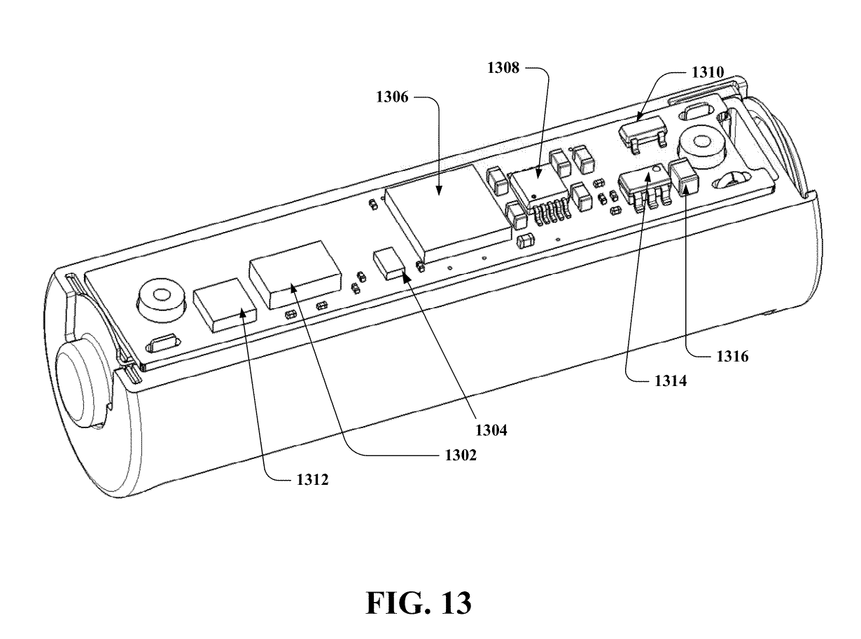

FIGS. 11A and 11B are views illustrating housings 1100, 1102 that facilitate terminal connections to the primary battery for the battery-powered device. The housings 1100, 1102 are shown with the housing covers removed to expose the internal components. The positive terminal 1104 can connect the positive external anode 1106 for any additional batteries included that are external to the housing 1100,1102, the anode of the internal AAA battery (not shown) and the positive V+ terminal (not shown) to the circuit board. The negative terminal 1108 can form the conventional cathode of the control device serving as an AA form-factor equivalent battery, and through the sheet metal tab, make the negative V− connection to the circuit board (as later shown and described with reference to FIG. 13).

The common terminal with power cell can be as shown at the positive terminal 1104. The primary spring of the power cell can be at the negative terminal 1108.

FIGS. 12A and 12B illustrate diagrams of selected components for the housing of FIGS. 11A and 11B. FIG. 12A illustrates a primary spring 1202 and an external cell sheet metal stamping 1204. The spring and external cell sheet metal stamping are at the negative terminal FIG. 12B illustrates a primary stamping 1206 in contact with the external cell stamping 1208. The primary stamping is at the positive terminal In various embodiments, all terminal connections to the PCB can be thru-hole soldered.

Referring to the disclosure of FIGS. 11A, 11B, 12A and 12B, in one or more embodiments, the anode for both the AA and AAA batteries are electrically equivalent. The positive terminal of the AAA battery can contact primary stamping 1206 and external cell stamping 1208. External cell stamping 1208 can act as the positive terminal of the AA form-factor equivalent terminal

FIG. 13 illustrates a schematic diagram of a printed circuit board of the control device for controlling battery-powered devices. In various embodiments, the printed circuit board (PCB) can be included within the housing for the battery of the battery-powered device. For example, the PCB can be included within the housing shown in FIGS. 10A, 10B, 11A and 11B.

In some embodiments, the PCB 1300 can include an antenna (which can be a PCB trace) 1302, clock (e.g., crystal oscillator) 1304, BLUETOOTH® low energy (BLE) microprocessor 1306, boost converter 1308, N-channel MOSFET 1310, three-axis accelerometer 1312, operational amplifier 1314, and/or current sensing resistor 1316. In embodiments, one or more of the antenna 1302, clock 1304, BLE microprocessor 1306, boost converter 1308, n-channel MOSFET 1310, three-axis accelerometer 1312, operational amplifier 1314 and/or current sensing resistor 1316 can be electrically and/or communicatively coupled to one another to perform one or more functions of the control device.

In some embodiments, the antenna 1302, clock 1304, microprocessor 1306, boost converter 1308, N-channel MOSFET 1310 and three-axis accelerometer 1312 can include one or more of the structure and/or the functionality of antenna 214, clock 216, microcontroller 208, boost converter 206, N-channel MOSFET 202, accelerometer 212 of FIG. 2 (or vice versa). In some embodiments, the operational amplifier 1314 and current sensing resistor 1316 can include one or more of the structure and/or functionality of the operational amplifier/current and voltage sensing circuitry 204 (or vice versa).

While not labeled, the schematic diagram of FIG. 13 also illustrates various other components such as resistors and/or capacitors that can be employed for the operation of the control device.

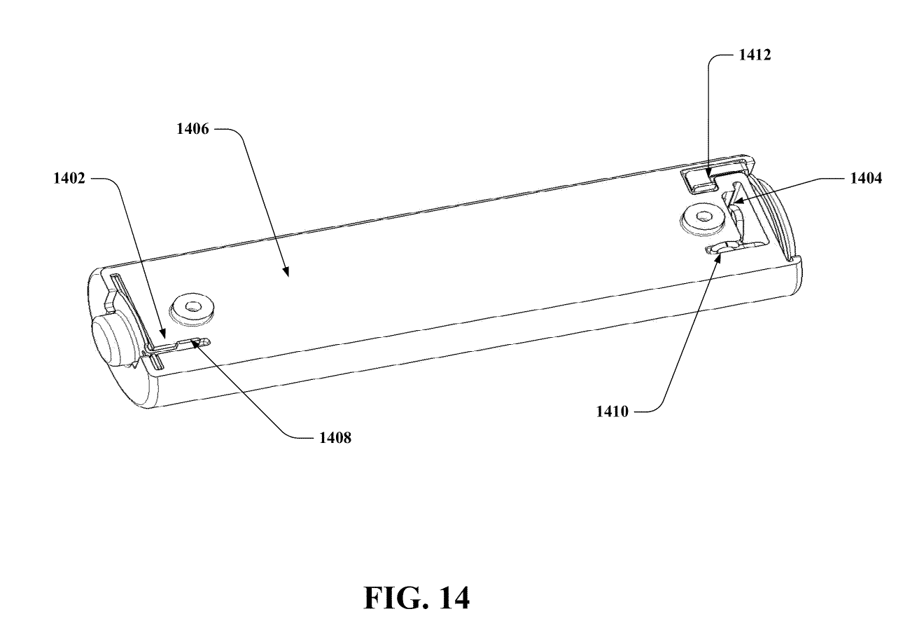

FIG. 14 illustrates a diagram of a top view of a housing for a printed circuit board of the control device for controlling battery-powered devices. Shown is the upper half of the housing 1400 having slits 1402, 1404 configured to hold the battery terminals (not shown) in position. As such, the slits 1402, 1404 can receive, on the substantially flat, top portion 1406 of the housing 1400, portions of the circuit board (or portions of components to connect the circuit board to the battery that powers the circuit board). Once installed, the battery terminals each have a segment that will protrude through the board. At connection points 1408, 1410, 1412, the battery two terminals and a switch can be connected (e.g., soldered) to the circuit board.

The housing can accept metallic terminals and position the metallic terminals to engage the circuit board slots for final soldering and closeout of the housing. The sheet metal tab, a negative V− connection can be made to the circuit board. Specifically, the negative V− terminal can be made by a leg of the coil spring 1410 that is soldered through a hole of the PCB.

While not labeled, the schematic diagram of FIGS. 13 and 14 also illustrate various other components such as resistors and/or capacitors that can be employed for the operation of the control device.

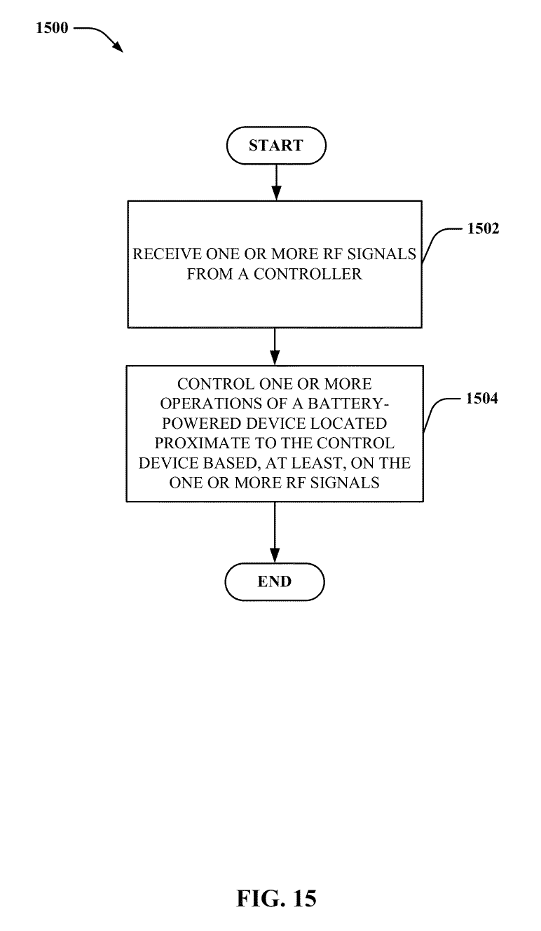

Turning first to FIG. 15, at 1502, method 1500 can include receiving one or more RF signals from a controller (e.g., at the control device 120, 200). In some embodiments, receiving is performed by a control device that is powered by a battery employed, at least, in part, in powering the battery-powered device. The battery-powered device can be at least one of a smoke detector, a carbon monoxide detector, a toy, a light of a bicycle or any number of other different types of battery-powered devices. In some embodiments, the control device includes a circuit board having a plurality of components, and is coupled to a cover for a battery housing for the battery-powered device.

At 1504, method 1500 can include controlling one or more operations of a battery-powered device located proximate to the control device based, at least, on the one or more RF signals (e.g., by the control device 200). In some embodiments, the operations can include, but are not limited to, de-activating an operation of the battery-powered device or activating an operation of the battery-powered device. In some embodiments, activation can be based on sensing motion at the battery-powered device. For example, activation can be performed after a period of time (e.g., 10 seconds) has passed since the motion was sensed.

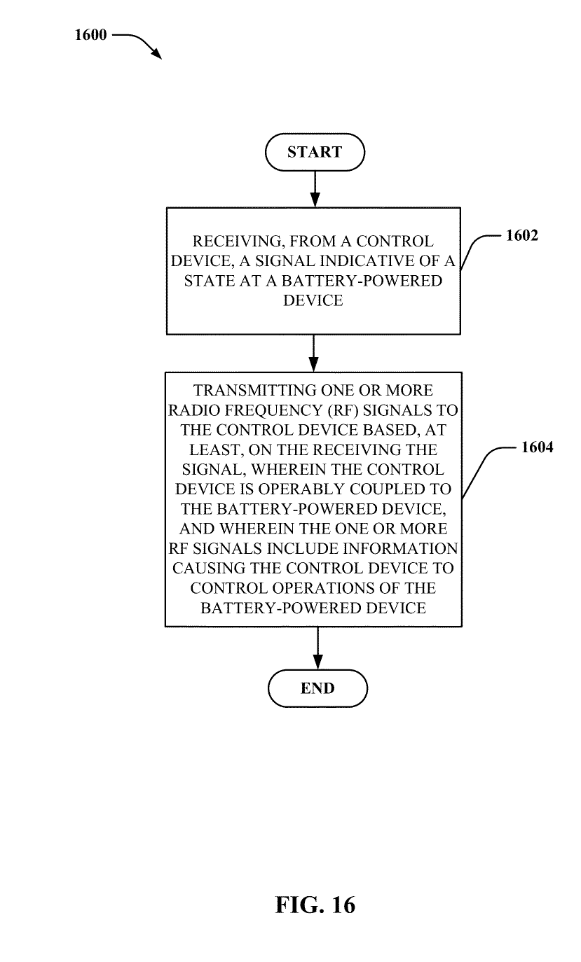

Turning now to FIG. 16, at 1602, method 1600 can include receiving, from a control device, a signal indicative of a state at a battery-powered device (e.g., using the controller 110). In some embodiments, the receiving can be performed by a controller located remote from the control device. For example, the controller can be a mobile device. The mobile device can be configured to be a smart phone, key fob or the like.

In some embodiments, the mobile device can be communicatively coupled to the Internet, to a network in the home in which the control device is located. In some embodiments, the mobile device and the control device can communicate over a BLUETOOTH ® communication channel.

The mobile device can be configured to communicate with one or more social networking websites and/or to send or receive SMS messages.

At 1604, method 1600 can include transmitting one or more radio frequency (RF) signals to the control device based, at least, on the receiving the signal, wherein the control device is operably coupled to the battery-powered device, and wherein the one or more RF signals include information causing the control device to control operations of the battery-powered device (e.g., using the controller 110).

In some embodiments, the method can include: receiving information indicative of a state of the battery-powered device sensed by the control device; and searching the Internet for information corresponding to the state. Accordingly, in some embodiments, transmitting the RF signals can be based, at least, on the information retrieved from the Internet.

The information retrieved from the Internet (or the information indicative of the state of the battery-powered device) can be communicated to a social media network in various embodiments.

In another embodiment, a method can include detecting an acceleration of a battery-powered device operably coupled to the system (e.g., using the control device 120, 200). The method can also include generating a first control signal configured to control the battery-powered device to perform one or more operations based, at least, on the detecting (e.g., using the control device 120, 200). In some embodiments, the one or more operations can include activating or de-activating the battery-powered device.

In some embodiments, the battery-powered device can be activated after a predefined amount of time has passed since detecting the acceleration. In some embodiments, the battery-powered device can be de-activated based, at least, on the acceleration detected exceeding a predefined threshold.

In some embodiments, the control signal can be generated independent of receipt of any signals from the controller 110 or other components outside of the battery-powered device.

In some embodiments, the method can also include communicating, with a controller communicatively coupled to the Internet, information associated with a state of the battery-powered device. Information can be received from the controller, to generate the control signal. The information can be based, at least, on information retrieved from the Internet by the controller.

In various embodiments, the systems and devices described herein can include one or more of the following components and/or can be configured or designed according to one or more of the following designs specifications. System and/or device may have an operational lifetime of at least 1 year assuming a duty cycle of 1 use per day. The components may be optimized to minimize quiescent current draw from the receiver's primary batteries.

The system and/or device may operate on a frequency that does not demand costly Federal Communications Commission (or other regulatory agency) certifications (e.g., 868 MHz).

The receivers and transmitters of the control device and controller can be included as matched units, requiring no operator/user setup. In some embodiments, additional receivers and/or transmitters can be included. Additionally, simple procedures/methods for setting the operating code can be employed. Such a procedure/method may include connecting the device to a docking station to learn a code. Alternatively the transmitter and receivers could have transceiver capability, allowing a unique code to be set up via a learn mode initiated by the transmitter, the receiver, or both.

In some embodiments, receivers and transmitters can have batteries that are easily changed, or potentially recharged in a docking station. For example, the circuitry of the battery can be integrated with the cell itself (as opposed to being two separate elements as detailed in the other embodiments described herein). In embodiments, wherein the cell element is rechargeable, a docking station can be used to charge the battery portion (e.g., Ni-Cad, Li-Ion, NiMh or other chemical formulation). In this embodiment, the receiver can be controlled to enter an alternate operational state (for example, by electrical contacts that are made only while connected to the docking station). These electrical contacts can be a means to transfer information between the docking station and the control device.

In some embodiments, the receiver and/or transmitter can be configured to switch a minimum of 500 mA. If technically feasible, larger current capacity switching can be performed.

In some embodiments, the transmitter of the controller can be sized to attach to a key chain and have separate on and off keys in the event that certain receivers in the control device are out of range during a transmit sequence.

The range of the transmission of the controller can be any number of feet to provide a signal that can reach a typical location of a control device at a battery-powered device within a home. By way of example, but not limitation, the range of the transmission can be greater than or equal to 70 feet. Embodiments with a greater range than 70 feet can be provided to provide greater effectiveness over a large dwelling. In various embodiments, other ranges are possible as only limited by wireless range of transmission and/or reliability. BLE, wireless LAN and/or wireless LAN alternatives such as ZigBee can be employed.

In some embodiments, the control devices can be designed to minimize the risk of being inadvertently activated or deactivated by other nearby RF sources or devices. In some embodiments, the other nearby RF sources or devices could be other controllers and/or other control devices as described herein.

In some embodiments, the control device is not intended for use in large current draw devices (e.g., a NIKKO® radio control toy car that would drain 8 AA batteries in less than 1 hour.) In some embodiments, a current switching feature can be included. As a precautionary measure, a fuse or safe mode may be employed in the control device to prevent or reduce the chance of overload of the solid-state switch (field effect transistor (FET) based device).

In some embodiments, a smart phone interface can be included in the system and can allow an application to control the control device receiver functions. The interface can include a module to plug into a cellphone (e.g., IPHONE® device, DROID® device, or similar device). In some embodiments, the smart phone interface would plug into the smart phone and translate the user intentions into appropriate RF signals should the operational frequency not be available as a built-in function of the computing device acting as the controller. For instance, in the context of the smart phones, the control devices may operate according to the BLE protocol or any other LAN or PAN (Peripheral Area Network) connectivity protocol. In some embodiments, there may be a period where a small dongle that plugs into the IPHONE® device, DROID® device or other device, and gives the device the BLE transmission and receive capability required to communicate with the receiver devices can be employed. In the context of a laptop, the dongle may be a small USB key similar to those used for wireless mice and keyboards. Other style dongles may be created as needed or desired.

Although a specific logical diagram and functional methodology is presented herein, numerous variations are possible that preserve the design intent of the device and are within the spirit of the invention, and may offer avenues for optimization that better achieve the high level product requirements, or spawn entirely new designs altogether.

Alternatively the logic gates and other scenarios may be handled by a microprocessor and/or firmware. Such microprocessors can be programmed with firmware to handle the behavior of the controller and/or the control device and optimize timeout periods for consumer demand and battery life optimization. For example, RFICs can employ microprocessors and can be programmed with firmware to accomplish one or more of the functions of the logical elements of the block diagram of FIG. 4, as well as the timing functions and the function of Q2. Therefore, the transceiver/MCU can replace numerous elements.

In various embodiments, the systems, devices, methods and/or computer readable media described herein can be employed in a host of different technologies. By way of example, but not limitation, the systems, devices, methods and/or computer-readable media described herein can be employed for controlling light arrays and fixtures (e.g., stadium lighting, entertainment center lighting, traffic signal lighting), healthcare devices (e.g., pacemakers, implanted medical devices), and swarm intelligence in battery-powered devices (e.g., robots, weapons, electric vehicles devices and systems). With regard to light arrays and fixtures, control of the power source level can be maintained. With regard to healthcare devices, more intelligent, timely and personal reporting of the device status can be achieved; quick and convenient monitoring of the status of the devices can be achieved, for example, by receipt of monitored data at the control device (e.g., smart phone or other device); and/or hospital tracking/monitoring of patient or healthcare device location and/or status. With regard to swarm intelligence, optimization algorithms can be employed across an array of intelligent batteries, the batteries can sense one another, exchange data and throttle power levels efficiently.

For example, over time electrochemical cells undergo changes that affect their internal resistance, nominal voltage and ultimately their current capacity. By embedding intelligence in battery arrays, more efficient methods of delivering charge to and from the cells could be achieved by tailoring the charge flow to be preferentially distributed to cells that are in a state of being able to absorb charge more rapidly, rather than distribute the charge through cells that are already at capacity and would otherwise liberate waste heat as a result of the unwanted current flow; potentially, should a given cell be near failure, a user could be alerted prior to a catastrophic power failure of an entire battery pack. Or, perhaps, should a single cell fail in a manner that would otherwise fail the entire array due to an open circuit, the smart battery could disconnect the electrochemical portion and enter a safe mode operation that effectively bridges the open circuit thus restoring operation of the larger battery array. Yet another potential behavior could be embedding temperature sensors in the smart batteries to monitor heat generation. Packs of batteries could be managed at the individual cell level to improve efficiency by preventing current flows from passing through high resistance cells at elevated temperatures, thus redirecting current flows through cooler cells.

In various embodiments, preferential treatment of individual cells within an array of other cells (in any context) and that of power saving can be aspects of the embodiments described herein. Concerning that of preferential treatment, cells within a larger power array now are, for the most part, treated equally. With the properly established algorithms and systems, a cell array could be analyzed at a granular level and made more efficient. Second, algorithms could be put in place as a part of a “green” initiative for electrochemical cells, allowing devices to throttle down power levels and/or shut off when the environment or parent device is in state where a reduction in supplied power is appropriate.

In another envisioned embodiment, a group of a control devices could be used as a part or extension of an existing fire safety system whereby any one control device could issue an alert to a base station if exposed to the intense heat of a fire that would cause a minimum threshold value of resistance across a thermistor sensor to be exceeded (thermistor is given as an example, other temperature sensing devices may be substituted). Such control devices would have a reasonable life span and would be operational indoors as well as outdoors. The control devices could be networked amongst one another (as in a peer-to-peer network) as well as connected to a monitoring network so that command and control could be conducted from a web application or a web-enabled smart phone.

In yet another envisioned embodiment, a group of control devices could be used as a part or extension of a home security system. In such a system, individual control devices could be distributed throughout or around a home or premises. The control devices could be configured to sense motion, sound, heat, etc. and subsequently report any movement to a base station or network. The control devices could be networked amongst one another (as in a peer-to-peer network) as well as connected to a monitoring network so that command control could be conducted from a web application or a web-enabled smart phone. This could present a significant enhancement to home security since the devices are capable of being concealed in non-obvious objects and can extend the resolution of an existing security system, or serve as a standalone system altogether that does not require any wiring to be installed and is portable, say, for apartment tenants.

Although not shown, an exemplary remote device for implementing one or more embodiments herein can include a general or special purpose computing device including the elements described herein for affecting the functions described. Components of the general or special purpose computing device computer may include, but are not limited to, a processing unit, a system memory, and a system bus that couples various system components including the system memory to the processing unit.

In one or more embodiments, the structure and/or functionality of various components (e.g., batteries, control devices, controllers, clocks, microcontrollers, microprocessors) can be or be included in one or more of the other components described herein. For example, the structure and/or functionality of control device 120 can be or include one or more of the structure and/or functionality of control device 200. As another example, the structure and/or functionality of battery 132 can be or include one or more of the structure and/or functionality of battery 220.

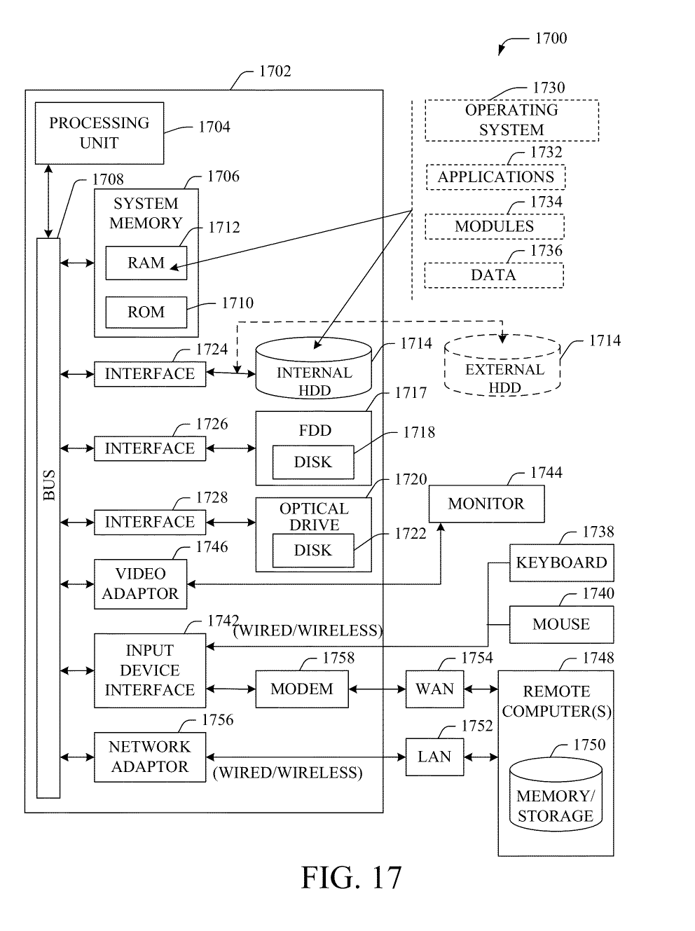

Referring now to FIG. 17, there is illustrated a block diagram of a computer operable to facilitate control of a battery-powered device. For example, in some embodiments, the computer can be or be included within the control device 120, 200, 300 (or components thereof), microcontroller 208, 308 and/or the controller 110 (or components thereof).

In order to provide additional context for various embodiments of the embodiments described herein, FIG. 17 and the following discussion are intended to provide a brief, general description of a suitable computing environment 1700 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data or unstructured data. Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 17, the example environment 1700 for implementing various embodiments of the aspects described herein includes a computer 1702, the computer 1702 including a processing unit 1704, a system memory 1706 and a system bus 1708. The system bus 1708 couples system components including, but not limited to, the system memory 1706 to the processing unit 1704. The processing unit 1704 can be any of various commercially available processors. Dual microprocessors and other multi-processor architectures can also be employed as the processing unit 1704.

The system bus 1708 can be any of several types of bus structure that can further interconnect to a memory bus (with or without a memory controller), a peripheral bus, and a local bus using any of a variety of commercially available bus architectures. The system memory 1706 includes ROM 1710 and RAM 1712. A basic input/output system (BIOS) can be stored in a non-volatile memory such as ROM, erasable programmable read only memory (EPROM), EEPROM, which BIOS contains the basic routines that help to transfer information between elements within the computer 1702, such as during startup. The RAM 1712 can also include a high-speed RAM such as static RAM for caching data.

The computer 1702 further includes an internal hard disk drive (HDD) 1714 (e.g., EIDE, SATA), which internal hard disk drive 1714 can also be configured for external use in a suitable chassis (not shown), a magnetic floppy disk drive (FDD) 1716, (e.g., to read from or write to a removable diskette 1718) and an optical disk drive 1720, (e.g., reading a CD-ROM disk 1722 or, to read from or write to other high capacity optical media such as the DVD). The hard disk drive 1714, magnetic disk drive 1716 and optical disk drive 1720 can be connected to the system bus 1708 by a hard disk drive interface 1724, a magnetic disk drive interface 1726 and an optical drive interface 1728, respectively. The interface 1724 for external drive implementations includes at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1702, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 1712, including an operating system 1730, one or more application programs 1732, other program modules 1734 and program data 1736. All or portions of the operating system, applications, modules, and/or data can also be cached in the RAM 1712. The systems and methods described herein can be implemented utilizing various commercially available operating systems or combinations of operating systems.

A user can enter commands and information into the computer 1702 through one or more wired/wireless input devices, e.g., a keyboard 1738 and a pointing device, such as a mouse 1740. Other input devices (not shown) can include a graphical user interface of a mobile phone (e.g., smart phone), a key pad of a key fob, microphone, an infrared (IR) control, a joystick, a game pad, a stylus pen, touch screen or the like. These and other input devices are often connected to the processing unit 1704 through an input device interface 1742 that can be coupled to the system bus 1708, but can be connected by other interfaces, such as a parallel port, an IEEE 1394 serial port, a game port, a universal serial bus (USB) port, an IR interface, etc.

A monitor 1744 or other type of display device can be also connected to the system bus 1708 via an interface, such as a video adapter 1746. In addition to the monitor 1744, a computer typically includes other peripheral output devices (not shown), such as speakers, printers, etc.

The computer 1702 can operate in a networked environment using logical connections via wired and/or wireless communications to one or more remote computers, such as a remote computer(s) 1748. The remote computer(s) 1748 can be a workstation, a server computer, a router, a personal computer, portable computer, microprocessor-based entertainment appliance, a peer device or other common network node, and typically includes many or all of the elements described relative to the computer 1702, although, for purposes of brevity, only a memory/storage device 1750 is illustrated. The logical connections depicted include wired/wireless connectivity to a local area network (LAN) 1752 and/or larger networks, e.g., a wide area network (WAN) 1754. Such LAN and WAN networking environments are commonplace in offices and companies, and facilitate enterprise-wide computer networks, such as intranets, all of which can connect to a global communications network, e.g., the Internet.

When used in a LAN networking environment, the computer 1702 can be connected to the local network 1752 through a wired and/or wireless communication network interface or adapter 1756. The adapter 1756 can facilitate wired or wireless communication to the LAN 1752, which can also include a wireless AP disposed thereon for communicating with the wireless adapter 1756.

When used in a WAN networking environment, the computer 1702 can include a modem 1758 or can be connected to a communications server on the WAN 1754 or has other means for establishing communications over the WAN 1754, such as by way of the Internet. The modem 1758, which can be internal or external and a wired or wireless device, can be connected to the system bus 1708 via the input device interface 1742. In a networked environment, program modules depicted relative to the computer 1702 or portions thereof, can be stored in the remote memory/storage device 1750. It will be appreciated that the network connections shown are example and other means of establishing a communications link between the computers can be used.

The computer 1702 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands, at an 11 Mbps (802.11a) or 54 Mbps (802.11b) data rate, for example or with products that contain both bands (dual band), so the networks can provide real-world performance similar to the basic 10BaseT wired Ethernet networks used in many offices.

### EXEMPLARY NETWORKED AND DISTRIBUTED ENVIRONMENTS

One of ordinary skill in the art can appreciate that the various embodiments described in this disclosure can be implemented in connection with any computer or other client or server device, which can be deployed as part of a computer network or in a distributed computing environment, and can be connected to any kind of data store where iris prescription information may be found. For example, the control component described herein can be communicatively coupled to a computer or other client or server device that stores prescription information. In this regard, the various embodiments described in this disclosure can be implemented in association with any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services can also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the various embodiments of this disclosure.

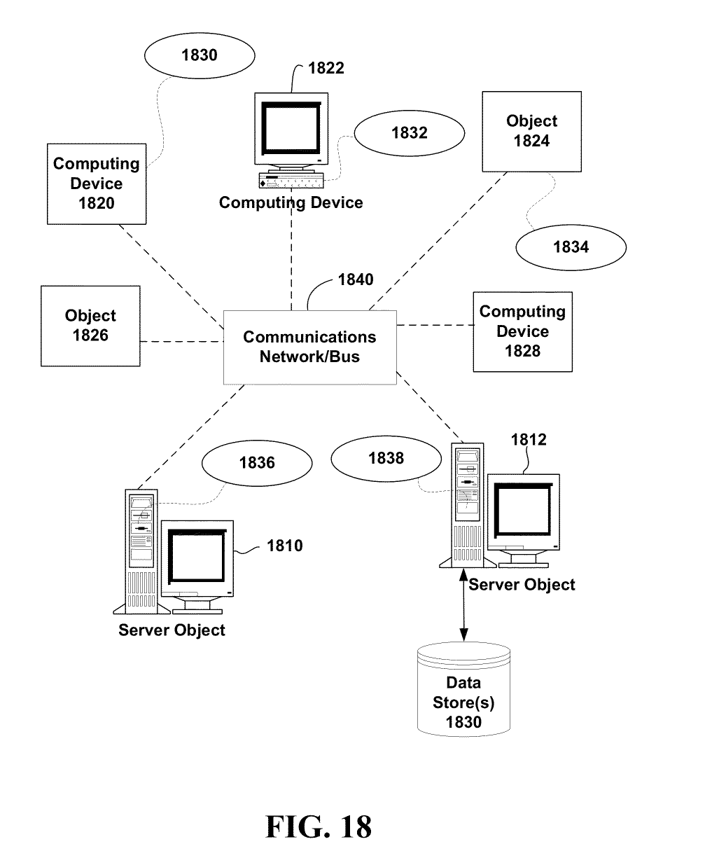

FIG. 18 provides a schematic diagram of an exemplary networked or distributed computing environment with which one or more embodiments described in this disclosure can be associated. The distributed computing environment includes computing objects 1810, 1812, etc. and computing objects or devices 1820, 1822, 1824, 1826, 1828, etc., which can include programs, methods, data stores, programmable logic, etc., as represented by applications 1830, 1832, 1834, 1836, 1838. It can be appreciated that computing objects 1810, 1812, etc. and computing objects or devices 1820, 1822, 1824, 1826, 1828, etc. can include different devices, such as personal digital assistants (PDAs), audio/video devices, mobile phones, MPEG-1 Audio Layer 3 (MP3) players, personal computers, laptops, tablets, etc.

Each computing object 1810, 1812, etc. and computing objects or devices 1820, 1822, 1824, 1826, 1828, etc. can communicate with one or more other computing objects 1810, 1812, etc. and computing objects or devices 1820, 1822, 1824, 1826, 1828, etc. by way of the communications network 1840, either directly or indirectly. Even though illustrated as a single element in FIG. 18, network 1840 can include other computing objects and computing devices that provide services to the system of FIG. 18, and/or can represent multiple interconnected networks, which are not shown. Each computing object 1810, 1812, etc. or computing objects or devices 1820, 1822, 1824, 1826, 1828, etc. can also contain an application, such as applications 1830, 1832, 1834, 1836, 1838, that might make use of an application programming interface (API), or other object, software, firmware and/or hardware, suitable for communication with or implementation of the various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems as described in various embodiments.

Thus, a host of network topologies and network infrastructures, such as client/server, peer-to-peer, or hybrid architectures, can be utilized. The client can be a member of a class or group that uses the services of another class or group. A client can be a computer process, e.g., roughly a set of instructions or tasks, that requests a service provided by another program or process. A client can utilize the requested service without having to know all working details about the other program or the service itself.

In a client/server architecture, particularly a networked system, a client can be a computer that accesses shared network resources provided by another computer, e.g., a server. In the illustration of FIG. 18, as a non-limiting example, computing objects or devices 1620, 1622, 1624, 1626, 1628, etc. can be thought of as clients and computing objects 1610, 1612, etc. can be thought of as servers where computing objects 1610, 1612, etc. provide data services, such as receiving data from client computing objects or devices 1620, 1622, 1624, 1626, 1628, etc., storing of data, processing of data, transmitting data to client computing objects or devices 1620, 1622, 1624, 1626, 1628, etc., although any computer can be considered a client, a server, or both, depending on the circumstances. Any of these computing devices can process data, or request transaction services or tasks that can implicate the techniques for systems as described in this disclosure for one or more embodiments.

A server can be typically a remote computer system accessible over a remote or local network, such as the Internet or wireless network infrastructures. The client process can be active in a first computer system, and the server process can be active in a second computer system, communicating with one another over a communications medium, thus providing distributed functionality and allowing multiple clients to take advantage of the information-gathering capabilities of the server. Any software objects utilized pursuant to the techniques described in this disclosure can be provided standalone, or distributed across multiple computing devices or objects.

In a network environment in which the communications network/bus 1840 can be the Internet, for example, the computing objects 1810, 1812, etc. can be Web servers, file servers, media servers, etc. with which the client computing objects or devices 1820, 1822, 1824, 1826, 1828, etc. communicate via any of a number of known protocols, such as the hypertext transfer protocol (HTTP). Objects 1810, 1812, etc. can also serve as client computing objects or devices 1820, 1822, 1824, 1826, 1828, etc., as can be characteristic of a distributed computing environment.

As used in this application, the terms “component,” “component,” “system,” and the like are intended to refer to a computer-related entity, either hardware, software, firmware, a combination of hardware and software, software and/or software in execution. For example, a component can be, but is not limited to being, a process running on a processor, a processor, an object, an executable, a thread of execution, a program, and/or a computer. By way of illustration, both an application running on a computing device and/or the computing device can be a component. One or more components can reside within a process and/or thread of execution and a component can be localized on one computer and/or distributed between two or more computers. In addition, these components can execute from various computer-readable storage media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

### Exemplary Computing Device

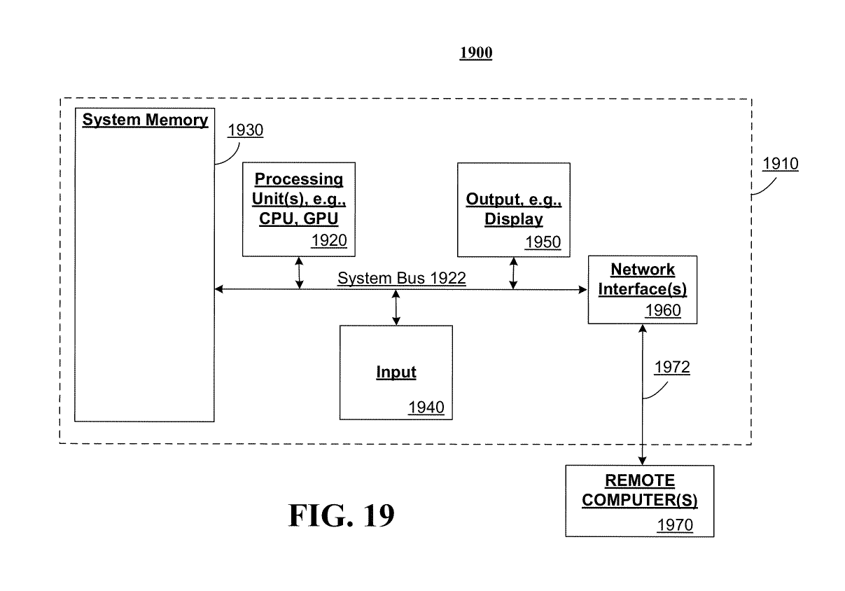

As mentioned, advantageously, the techniques described in this disclosure can be associated with any suitable device. It is to be understood, therefore, that handheld, portable and other computing devices and computing objects of all kinds are contemplated for use in connection with the various embodiments, i.e., anywhere that a device may wish to read or write transactions from or to a data store. Accordingly, the below remote computer described below in FIG. 19 is but one example of a computing device. Additionally, a suitable server can include one or more aspects of the below computer, such as a user fingerprint server, a biometric identification server or other server components.

Although not required, embodiments can be partly implemented via an operating system, for use by a developer of services for a device or object, and/or included within application software that operates to perform one or more functional aspects of the various embodiments described in this disclosure. Software can be described in the general context of computer executable instructions, such as program components, being executed by one or more computers, such as client workstations, servers or other devices. Those skilled in the art will appreciate that computer systems have a variety of configurations and protocols that can be used to communicate data, and thus, no particular configuration or protocol is to be considered limiting.

FIG. 19 thus illustrates an example of a suitable computing system environment 1900 in which one or aspects of the embodiments described in this disclosure can be implemented, although as made clear above, the computing system environment 1900 is only one example of a suitable computing environment and is not intended to suggest any limitation as to scope of use or functionality. Neither is the computing environment 1900 to be interpreted as having any dependency or requirement relating to any one or combination of components illustrated in the exemplary computing environment 1900.

With reference to FIG. 19, an exemplary computing environment 1900 for implementing one or more embodiments includes a computing device in the form of a computer 1910 is provided. Components of computer 1910 can include, but are not limited to, a processing unit 1920, a system memory 1930, and a system bus 1922 that couples various system components including the system memory to the processing unit 1920.

Computer 1910 typically includes a variety of computer readable media and can be any available media that can be accessed by computer 1910. The system memory 1930 can include computer storage media in the form of volatile and/or nonvolatile memory such as read only memory (ROM) and/or random access memory (RAM). By way of example, and not limitation, memory 1930 can also include an operating system, application programs, other program components, and program data.

A user can enter commands and information into the computer 1910 through input devices 1940, non-limiting examples of which can include a keyboard, keypad, a pointing device, a mouse, stylus, touchpad, touch screen, trackball, motion detector, camera, microphone, joystick, game pad, scanner, video camera or any other device that allows the user to interact with the computer 1910. A monitor or other type of display device can be also connected to the system bus 1922 via an interface, such as output interface 1950. In addition to a monitor, computers can also include other peripheral output devices such as speakers and a printer, which can be connected through output interface 1950.

The computer 1910 can operate in a networked or distributed environment using logical connections to one or more other remote computers, such as remote computer 1980. The remote computer 1980 can be a personal computer, a server, a router, a network PC, a peer device or other common network node, or any other remote media consumption or transmission device, and can include any or all of the elements described above relative to the computer 1910. The logical connections depicted in FIG. 19 include a network 1982, such local area network (LAN) or a wide area network (WAN), but can also include other networks/buses e.g., cellular networks.

As mentioned above, while exemplary embodiments have been described in connection with various computing devices, networks and architectures, the underlying concepts may be applied to any network system and any computing device or system in which it is desirable to publish, build applications for or consume data in connection with interactions with a cloud or network service.

There are multiple ways of implementing one or more of the embodiments described herein, e.g., firmware, an appropriate API, tool kit, driver code, operating system, control, standalone or downloadable software object, etc. which enables applications and services to use the infrastructure for information as a service from any platform. Embodiments may be contemplated from the standpoint of an application programming interface (API) (or other software object), as well as from a software or hardware object that facilitates provision of an infrastructure for information as a service from any platform in accordance with one or more of the described embodiments. Various implementations and embodiments described herein may have aspects that are wholly in hardware, partly in hardware and partly in software, as well as in software.

As mentioned above, while exemplary embodiments have been described in connection with various computing devices and network architectures, the underlying concepts can be applied to any network system and any computing device or system in which it is desirable to publish or consume media in a flexible way.

Also, there are multiple ways to implement the same or similar functionality, e.g., an appropriate API, tool kit, driver code, operating system, control, standalone or downloadable software object, etc. which enables applications and services to take advantage of the techniques detailed herein. Thus, embodiments herein are contemplated from the standpoint of an API (or other software object), as well as from a software or hardware object that implements one or more aspects described in this disclosure. Thus, various embodiments described in this disclosure can have aspects that are wholly in hardware, partly in hardware and partly in software, as well as in software.

Computing devices typically include a variety of media, which can include computer-readable storage media and/or communications media, in which these two terms are used herein differently from one another as follows. Computer-readable storage media can be any available storage media that can be accessed by the computer, can be typically of a non-transitory nature, and can include both volatile and nonvolatile media, removable and non-removable media. By way of example, and not limitation, computer-readable storage media can be implemented in connection with any method or technology for storage of information such as computer-readable instructions, program components, structured data, or unstructured data. Computer-readable storage media can include, but are not limited to, RAM, ROM, electrically erasable programmable read only memory (EEPROM), flash memory or other memory technology, compact disc read only memory (CD-ROM), digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program components or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, radio frequency (RF), infrared and other wireless media.

It is to be understood that the embodiments described in this disclosure can be implemented in hardware, software, firmware, middleware, microcode, or any combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors and/or other electronic units designed to perform the functions described in this disclosure, or a combination thereof.

When the embodiments are implemented in software, firmware, middleware or microcode, program code or code segments, they can be stored in a machine-readable medium (or a computer-readable storage medium), such as a storage component. A code segment can represent a procedure, a function, a subprogram, a program, a routine, a subroutine, a component, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

For a software implementation, the techniques described in this disclosure can be implemented with components or components (e.g., procedures, functions, and so on) that perform the functions described in this disclosure. The software codes can be stored in memory units and executed by processors. A memory unit can be implemented within the processor or external to the processor, in which case it can be communicatively coupled to the processor via various structures.

The word “exemplary” is used herein to mean serving as an example, instance, or illustration. For the avoidance of doubt, the subject matter disclosed herein is not limited by such examples. In addition, any aspect or design described in this disclosure as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

What has been described above includes examples of one or more embodiments. It is, of course, not possible to describe every conceivable combination of components or methodologies for purposes of describing the aforementioned embodiments, but one of ordinary skill in the art can recognize that many further combinations and permutations of various embodiments are possible. Accordingly, the described embodiments are intended to embrace all such alterations, modifications and variations that fall within the spirit and scope of the appended claims. Moreover, use of the term “an embodiment” or “one embodiment” throughout is not intended to mean the same embodiment unless specifically described as such. Further, use of the term “plurality” can mean two or more.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it is to be noted that one or more components can be combined into a single component providing aggregate functionality or divided into several separate sub-components, and that any one or more middle layers, such as a management layer, can be provided to communicatively couple to such sub-components in order to provide integrated functionality. Any components described in this disclosure can also interact with one or more other components not specifically described in this disclosure but generally known by those of skill in the art.

In view of the exemplary systems described above methodologies that can be implemented in accordance with the described subject matter will be better appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks can occur in different orders and/or concurrently with other blocks from what is depicted and described in this disclosure. Where non-sequential, or branched, flow is illustrated via flowchart, it can be appreciated that various other branches, flow paths, and orders of the blocks, can be implemented which achieve the same or a similar result. Moreover, not all illustrated blocks can be required to implement the methodologies described in this disclosure after.

In addition to the various embodiments described in this disclosure, it is to be understood that other similar embodiments can be used or modifications and additions can be made to the described embodiment(s) for performing the same or equivalent function of the corresponding embodiment(s) without deviating there from. Still further, multiple processing chips or multiple devices can share the performance of one or more functions described in this disclosure, and similarly, storage can be provided across a plurality of devices. The invention is not to be limited to any single embodiment, but rather can be construed in breadth, spirit and scope in accordance with the appended claims.

The embodiments described herein can employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of the each cell site of the acquired network. A classifier is a function that maps an input attribute vector, x=(x1, x2, x3, x4, . . . , xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to a predetermined criteria which of the acquired cell sites will benefit a maximum number of subscribers and/or which of the acquired cell sites will add minimum value to the existing communication network coverage, etc.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

Memory disclosed herein can include volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM) or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory (e.g., data storages, databases) of the embodiments are intended to comprise, without being limited to, these and any other suitable types of memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter will be better appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

While in some embodiments, a client side perspective is illustrated, it is to be understood for the avoidance of doubt that a corresponding server perspective exists, or vice versa. Similarly, where a method is practiced, a corresponding device can be provided having storage and at least one processor configured to practice that method via one or more components.

While the various embodiments have been described in connection with the preferred embodiments of the various figures, it is to be understood that other similar embodiments may be used or modifications and additions may be made to the described embodiment for performing the same function without deviating therefrom. Still further, one or more aspects of the above described embodiments may be implemented in or across a plurality of processing chips or devices, and storage may similarly be affected across a plurality of devices. Therefore, the present invention should not be limited to any single embodiment, but rather should be construed in breadth and scope in accordance with the appended claims.

What is claimed is:

1. A control device including radio frequency (RF) circuitry and configured to:
receive one or more RF signals from a controller; and
control one or more operations of a battery-powered device located proximate to the control device based, at least, on the one or more RF signals.

2. The control device of claim 1, wherein the control device is powered by a battery employed, at least, in part, in powering the battery-powered device.

3. The control device of claim 1, wherein the one or more operations comprise at least one of: de-activating an operation of the battery-powered device or activating an operation of the battery-powered device.

4. The control device of claim 1, wherein the control device is further configured to sense a motion of the battery-powered device.

5. The control device of claim 4, wherein the control device is further configured to control the battery-powered device to activate based, at least, on a sensed motion of the battery-powered device.

6. The control device of claim 5, wherein the control to activate the battery-powered device comprises control to activate the battery-powered device after a predefined amount of time has passed since the motion was sensed.

7. The control device of claim 1, wherein the battery-powered device is at least one of a smoke detector, a carbon monoxide detector, a component configured to emit light or a toy.

8. The control device of claim 1, wherein the control device comprises a circuit board having a plurality of components, wherein the circuit board is coupled to a cover for a battery housing for the battery-powered device, and wherein one or more of the plurality of components are powered via connections between a battery in the battery housing, and the one or more of the plurality of components.

9. A non-transitory computer-readable storage medium storing computer-executable instructions that, in response to execution, cause a system including a processor to perform operations, comprising:
receiving, from a control device, a signal indicative of a state of a battery-powered device; and
transmitting one or more radio frequency (RF) signals to the control device based, at least, on the receiving the signal, wherein the control device is operably coupled to the battery-powered device, and wherein the one or more RF signals include information causing the control device to control operations of the battery-powered device.

10. The non-transitory computer-readable storage medium of claim 9, wherein the non-transitory computer-readable storage medium is located within a mobile device.

11. The non-transitory computer-readable storage medium of claim 10, wherein the mobile device is communicatively coupled to an Internet and is configured to communicate with at least one of a social media network or a short message service (SMS) network.

12. The non-transitory computer-readable storage medium of claim 11, wherein the operations further comprise:
communicating the information indicative of the state via an SMS message.

13. The non-transitory computer-readable storage medium of claim 11, wherein the operations further comprise:
searching the Internet for information corresponding to the state.

14. The non-transitory computer-readable storage medium of claim 13, wherein the operations further comprise:
communicating the information retrieved from the Internet to the social media network.

15. A computer-implemented method, comprising:
detecting, by a system including at least one processor, an acceleration of a battery-powered device operably coupled to the system; and
generating, by the system, a first control signal configured to control the battery-powered device to perform one or more operations based, at least, on the detecting.

16. The computer-implemented method of claim 15, wherein the one or more operations comprise activating the battery-powered device after a predefined amount of time has passed since the detecting the acceleration.

17. The computer-implemented method of claim 15, wherein the one or more operations comprise de-activating the battery-powered device based, at least, on the acceleration detected exceeding a predefined threshold.

18. The computer-implemented method of claim 15, further comprising:
receiving, by the system, a radio frequency (RF) signal that includes information to generate the first control signal, wherein the receiving is from a controller within broadcasting range of the system.

19. The computer-implemented method of claim 15, further comprising:
communicating, by the system, with a controller communicatively coupled to an Internet, information associated with a state of the battery-powered device; and
receiving, by the system, from the controller, information to generate the first control signal, wherein the information is based, at least, on information retrieved from the Internet by the controller.

20. The computer-implemented method of claim 19, wherein the receiving from the controller comprises receiving from at least one of a mobile device communicatively coupled to the Internet.

21. A control device, comprising:
an application specific integrated circuit (ASIC) configured to:
process one or more radio frequency (RF) signals; and
generate signals to control one or more operations of a device located proximate to the control device based, at least, on the one or more RF signals, wherein the ASIC is coupled to a battery housing for the device; and
an antenna coupled to the battery housing.

22. The control device of claim 21, wherein the antenna is at least one of printed on, printed beneath or integrated with the battery housing.

23. The control device of claim 21, wherein the battery housing is configured to receive at least one of an AAA battery or an AAAA battery.
